(19) United States
(12) Patent Application Publication
(10) Pub. No.: US 2026/0024259 A1
(43) Pub. Date: Jan. 22, 2026

(54) METHOD AND APPARATUS

(71) Applicant: THE UNIVERSITY OF LIVERPOOL, Liverpool (GB)

(72) Inventors: Nigel BROWNING, Liverpool (GB); Daniel NICHOLLS, Liverpool (GB); Alex ROBINSON, Liverpool (GB); Jack WELLS, Liverpool (GB)

(21) Appl. No.: 19/099,336

(22) PCT Filed: Jul. 31, 2023
(86) PCT No.: PCT/GB2023/052019

§ 371 Date: Jan. 28, 2025

(30) Foreign Application Priority Data
Jul. 29, 2022 (GB) 2211086.0

(51) Int. Cl. G06T 11/00; G06V 10/40; G06V 10/772; G06V 10/774

(52) U.S. Cl. CPC G06T 11/008; G06T 11/006; G06V 10/513; G06V 10/772; G06V 10/774

(57) ABSTRACT

A method of reconstructing an electron microscopy image of size [Mx N] pixels of a first sample, the method implemented by a computer comprising a processor and a memory, the method comprising:
providing a set of pre-learned dictionaries, including a first pre-learned dictionary including a set of p₁ atoms;
acquiring a sparse set of S acquired sub-images, including a first sub-image of size [a×b] pixels wherein a, b∈[2, min {M,N}], of the first sample; and reconstructing the electron microscopy image of the first sample using the sparse set of S sub-images of the first sample and the set of pre-learned dictionaries.

### FIELD

The present invention relates to reconstruction of images, for example electron microscopy images.

### BACKGROUND TO THE INVENTION

Over the last few decades, major developments in scanning transmission electron microscopy (STEM) such as modern aberration-correctors have enabled material scientists to analyse and characterise materials at the highest possible spatial resolution, allowing for atomic-scale observations of a materials structure, composition, and chemical properties. However, this unprecedented increase in achievable resolution has come at the cost of an increased operational probe current, now typically several orders of magnitude above that which many materials can withstand without significant damage to the sample. The effect of this is the shifting of the limiting factor from the physical properties of the instrument to that of the sample itself; in particular, the sensitivity of the sample to electron beam damage. In recent years, compressive sensing (CS) has been successfully applied to the field of low-dose STEM, where a deliberately subsampled (incomplete) scan is performed, acquiring an image with fewer pixels than in a regular raster scan, and reconstructing a fully sampled image from the reduced measurements. CS-STEM has been shown to reduce the dose, dose rate, and dose overlap necessary to recover a fully sampled image, all of which directly contribute to electron beam-damage, allowing (for example) high-angle annular dark field (HAADF) images of calcium carbonate (CaCO₃) to be acquired without significant amorphization of the sample.

By manipulating the scanning coils in such a way as to perform an incomplete scan, i.e. taking measurements at only a subset of the pixels (e.g. 25%), not only does the sample receive a lower electron-dose per frame (and thus enable more sensitive materials to be imaged), the framerate (or inversely, acquisition time) is also improved. This may be particularly beneficial for those taking many independent images to form a 3D data cube, such as in cryo-FIB tomography, as well as those interested in imaging time-dependent phenomena. Furthermore, the reduced acquisition time may have the additional benefit of reducing time-related instabilities in the microscope, such as sample drift, potentially improving the image quality of a regular scan.

Once a subsampled scan has been taken, it must then be passed to a reconstruction (image inpainting) process, usually solving a system of underdetermined linear equations, where most of the time penalty is incurred. This process will often take the form of a combination of a dictionary learning algorithm, and a sparse coding step algorithm, and a reconstruction step, though there has been significant work in developing machine learning alternatives. Traditional image inpainting methods rely on a dictionary learning algorithm such as the Method of Optimal Directions (MOD) or K-SVD, an algorithm which forms a dictionary of representative signal patterns from a fully sampled image, which (via a sparse linear combination with corresponding scalar coefficients) can closely represent any given patch of the image. This dictionary, along with a now (often artificially) subsampled version of the same image may then be passed to a sparse pursuit algorithm to solve the following system of equations (for each overlapping patch of the image):

$${ν}_{i} = {Φ}_{i} \cdot ( D {α}_{i} + {ϵ}_{i} ) \qquad ( Equation 1 )$$

$$= D {α}_{i} \qquad ( Equation 2 )$$

where vᵢ∈ [symbol] ⁿ is the measured (subsampled) signal subject to noise ϵ∈ [symbol] ⁿ, Φᵢ is the binary sensing matrix (or ‘mask’, determining the locations of missing pixels), [symbol] ∈ [symbol] ⁿ is the reconstructed (fully-sampled) signal represented using the given dictionary D∈ [symbol] ^{n×k} and corresponding ‘weight’ vector α∈ [symbol] ^{k}. Examples of algorithms capable of solving this includes Orthogonal Matching Pursuit (OMP) and its many similar variants which minimise the lo norm of the solution to induce sparsity or Basis Pursuit which minimises the I₁ norm. More recently, a reformulation of the dictionary learning problem into the Bayesian regime has produced algorithms, such as Beta-Process Factor Analysis (BPFA) which are capable of so-called ‘blind inpainting’, i.e. the formation of a dictionary, and subsequent reconstruction of an image using only the subsampled image as its input (therefore, there is no need for a mask to be provided a priori or a fully-sampled version of the image to be acquired at any stage in the process).

Any of these methods, assuming appropriate parameters, is capable of producing a high-quality reconstruction of the fully sampled image and has been successfully applied to the field of STEM. However, in addition to the time taken for the sparse-coding/reconstruction step (inherent to all inpainting methods), all of the aforementioned techniques present some form of challenge to ‘real-time’ CS-STEM, i.e. aligning and operating the microscope via a live preview of the sample from subsampled acquisition only. For traditional dictionary learning methods, this challenge is the need for a fully sampled image to train an appropriate dictionary, which is impossible for beam-sensitive materials. For blind inpainting methods, it is the time required to learn a unique dictionary from each subsampled image/frame, a computational overhead likely to severely limit the framerate of any real-time CS-STEM setup.

While a final high-quality reconstruction of the captured image may be performed post-acquisition, without too much concern for processing time, a true real-time CS-STEM application (in which only a subsampled scan of a beam-sensitive material is ever performed) must have a time-to-solution fast enough to enable the operator to perform live tasks such as focusing and alignment of the microscope. For this reason, the ‘solution time’ for inpainting tasks is crucial; and therefore, removing unnecessary and/or computationally expensive tasks (at least during the pre-acquisition stage) is essential.

One example of such a step is the dictionary learning process, a significantly expensive part of the algorithm which is necessary for any ‘blind inpainting’ method to produce a fully sampled image. Most previous work on dictionary learning and inpainting relies on either an ‘off the shelf’ transform dictionary, such as the Discrete Cosine Transform (DCT) and wavelets or for a new and independent dictionary to be learned for every image, whether by means of fully-sampled dictionary learning such as K-SVD, sub-sampled dictionary learning such as BPFA, or via the training of a neural network, such as an auto-encoder where the sparsifying ‘dictionary’ is effectively learned within the weights and biases of the model. In each of these scenarios, a learned dictionary (or trained network) is produced to be maximally effective at reconstructing the patches provided as training data (often originating from only one image), usually producing a high-quality reconstruction but requiring a significant amount of time and computational resources to obtain.

Hence, there is a need to improve analytical characterisation, for example by electron microscopy.

### SUMMARY OF THE INVENTION

It is one aim of the present invention, amongst others, to provide a method of reconstructing an electron microscopy image which at least partially obviates or mitigates at least some of the disadvantages of the prior art, whether identified herein or elsewhere.

A first aspect provides a method of reconstructing an electron microscopy image of size [M×N] pixels of a first sample, the method implemented by a computer comprising a processor and a memory, the method comprising:
providing a set of pre-learned dictionaries, including a first pre-learned dictionary including a set of p₁ atoms;
acquiring a sparse set of S acquired sub-images, including a first sub-image of size [a×b] pixels wherein a, b∈[2, min{M, N}], of the first sample; and
reconstructing the electron microscopy image of the first sample using the sparse set of S sub-images of the first sample and the set of pre-learned dictionaries.

A second aspect provides a method of controlling an electron microscope, the method implemented, at least in part, by a computer comprising a processor and a memory, the method comprising:
obtaining parameters of the electron microscopy;
acquiring a first sparse set of S acquired sub-images of a first sample comprising controlling the electron microscope using the obtained parameters of the electron microscopy;
reconstructing a first electron microscopy image of size [M×N] pixels of the first sample according to the first aspect and/or the sixth aspect using the first sparse set of S sub-images of the first sample;
comparing the first electron microscopy image against thresholds of one or more target properties of the first electron microscopy image;
adapting the parameters of the electron microscopy based on a result of the comparing; and
acquiring a second sparse set of S acquired sub-images of the first sample comprising controlling the electron microscope using the adapted parameters of the electron microscopy.

A third aspect provides a computer comprising a processor and a memory configured to implement a method according to any of the first aspect and/or the second aspect and/or the sixth aspect, a computer program comprising instructions which, when executed by a computer comprising a processor and a memory, cause the computer to perform a method according to any of the first aspect and/or the second aspect and/or the sixth aspect or a non-transient computer-readable storage medium comprising instructions which, when executed by a computer comprising a processor and a memory, cause the computer to perform a method according to any of the first aspect and/or the second aspect and/or the sixth aspect.

A fourth aspect provides an electron microscope including a computer comprising a processor and a memory configured to implement a method according to any of the first aspect and/or the second aspect and/or the sixth aspect.

A fifth aspect provides use of a pre-learned dictionary in reconstructing an electron microscopy image of a sample.

A sixth aspect provides a method of real-time dictionary transfer, the method implemented by a computer comprising a processor and a memory, the method comprising:
initialising an initial dictionary Do, for example wherein the initial dictionary is generated randomly or imported such as from a previous result, with parameters governing dimensionality and/or sparsity of the dictionary and/or Bayesian priors, for example denoting respective probabilities of element selection, noise variance, etc.;
initialising a first instance of BPFA with a transfer source Y₀ (i.e. a first input source such as a training image), wherein the first instance of BPFA comprises and/or is a training instance I₀ of BPFA, for example wherein the training instance/o of BPFA takes the transfer source Y₀ to be transferred from as an input thereof, having a first connection, for example a shared connection, to a transient dictionary Dₜ derived from the initial dictionary D₀;

initialising a second instance of BPFA with a target source Y₁ (i.e. a second input source such as a subsampled image to be inpainted), wherein the transfer source Y₀ and the target source Y₁ are mutually different, wherein the second instance of BPFA comprises and/or is a reconstruction instance I₁ of BPFA, for example wherein the reconstruction instance I₁ of BPFA takes an image to be transferred to as an input thereof, having a second connection, for example a shared connection, to the transient dictionary Dₜ (i.e. the same transient dictionary Dₜ);
performing one or more training iterations and reconstruction iterations (also known as loops), for example serially (i.e. sequentially, consecutively, alternately) and/or in parallel (i.e. simultaneously, concurrently), using the first instance of BPFA and the second instance of BPFA, respectively, comprising, for each respective training iteration and reconstruction iteration:
   updating, by the first instance of BPFA (i.e. the training instance I₀ of BPFA) during the training iteration (for example, during each training iteration), pixels of the transient dictionary Dₜ (and optionally, statistical parameters thereof, for example π, γ_{ϵ}, γ_{d}, γ_{ω}), whereby the transient dictionary D, learns the features of the transfer source Y₀; and
   updating, by the second instance of BPFA (i.e. the reconstruction instance I₁ of BPFA) during the reconstruction iteration (for example, during each reconstruction iteration), statistical parameters, for example π, γ_{ϵ}, γ_{d}, γ_{ω}) of the transient dictionary Dₜ, whereby the transient dictionary Dₜ converges, for example after a plurality of iterations, thereby containing features of the transfer source Y₀ and/or selection probabilities (such as BPFA priors/parameters) governed by the target source Y₁; and
producing, using the transient dictionary Dₜ, a visualisation [symbol] , representing a reconstruction of the target source Y₁.

### DETAILED DESCRIPTION OF THE INVENTION

According to the present invention there is provided a method of reconstructing an electron microscopy image, as set forth in the appended claims. Also provided is a method of controlling an electron microscope, a computer, a computer program, a non-transient computer-readable storage medium, an electron microscope and use of a pre-learned dictionary. Other features of the invention will be apparent from the dependent claims, and the description that follows.

The first aspect provides a method of reconstructing an electron microscopy image of size [M×N] pixels of a first sample, the method implemented by a computer comprising a processor and a memory, the method comprising:
providing a set of pre-learned dictionaries, including a first pre-learned dictionary including a set of p₁ atoms;
acquiring a sparse set of S acquired sub-images, including a first sub-image of size [a×b] pixels wherein a, b∈[2, min{M, N}], of the first sample; and
reconstructing the electron microscopy image of the first sample using the sparse set of S sub-images of the first sample and the set of pre-learned dictionaries.

In this way, the first pre-learned ‘master’ dictionary is used to reconstruct the electron microscopy image of the first sample. The inventors have determined that a high (enough) quality live preview of the first sample may be thus reconstructed before acquisition, for example, allowing an electron microscopy operator to perform to perform live tasks such as focusing and alignment of the microscope, as required, before acquiring a desired image of the sample. For materials which have already been previously imaged, and therefore a large volume of training data are available, this first pre-learned ‘master’ dictionary may be appropriate enough to skip the dictionary learning process altogether; for beam-sensitive materials, which have not been imaged previously, the method according to the first aspect provides a mechanism to avoid large parts of the computation in the dictionary learning step, effectively providing a “hot start” for the dictionary learning algorithm.

Particularly, the inventors have determined that the first pre-learned ‘master’ dictionary may be provided using one or more diverse images, different from the reconstructed electron microscopy image, for example having different fast Fourier transforms (FFTs), signal to noise ratios, intensities, features, periodicities and/or of samples of different materials and/or of different morphologies. That is, no a priori knowledge of the first sample may be required for reconstruction of the electron microscopy image thereof using the set of pre-learned dictionaries, for example the first pre-learned ‘master’ dictionary. In other words, the first pre-learned ‘master’ dictionary may be generically used for different samples and/or different sample types.

While each scan may be (visually) very different as the spatial position and/or magnification is altered, and thus may have different feature sizes, focus conditions and levels of noise arising from the electron microscope, the inventors have determined that the first pre-learned ‘master’ dictionary is nevertheless suitable. Described herein is the training a ‘master’ dictionary and its application to inpaint a wide variety of STEM images across varying microscope conditions. Particularly, the inventors have devised a number of experiments to test the efficacy of dictionary transfer (i.e. using a pre-learned ‘master’ dictionary on a different type of sample), and the general cross-compatibility of dictionaries learned from different images. In the experiments, while PSNR is conventionally stated as a reconstruction quality metric for all images, the inventors have found that PSNR (as well as SSIM) is a poor predictor of the true reconstruction quality for STEM images, as poorly reconstructed images which have lost almost all of the useful information in STEM analysis (such as atomic information) frequently return high PSNR values, similar to that of a good quality reconstruction, as discussed below.

While the method according to the first aspect relates to reconstructed electron microscopy images of samples, more generally, the method may be applied to reconstructions of images of samples acquired using other analytical techniques. Hence, more generally, the first aspect provides a method of reconstructing an image of size [M×N] pixels of a first sample due to interaction of electromagnetic radiation and/or particles with the first sample. It should be understood that the steps of the method according to the first aspect are implemented mutatis mutandis. In other words, while the method according to the first aspect relates to reconstructed electron microscopy images of samples, the method may be applied mutatis mutandis to other image reconstruction methods, for example for optical and X-ray techniques as well as reconstructions for basic physical properties such as band structure. Hence, more generally, the first aspect provides a method of reconstructing physical properties of a chemical, material and/or biological system and images produced of those systems by interaction with light, X-rays, protons, neutrons and/or electrons or by any other means.

The first aspect provides the method of reconstructing the electron microscopy image of size [M×N] pixels of the first sample. It should be understood that the electron microscopy image is reconstructed (i.e. synthesised, generated, calculated) using the computer (i.e. in silico) rather than completely acquired, for example using an electron microscope. It should be understood that the electron microscopy image is of the first sample and hence the first image is due to the interaction of electrons with the first sample, as defined by the obtained parameters of the electron microscopy and/or attributes of the sample. Electron microscopy is known. Electron microscopy images are known, for example transmission electron microscopy images, scanning electron microscopy images and electron diffraction patterns. Typically, electron microscopy images are stored in raw data formats (binary, bitmap, TIFF, MRC, etc.), other image data formats (PNG, JPEG) or in vendor-specific proprietary formats (dm3, emispec, etc.). The electron microscopy images may be compressed (preferably, lossless compression though lossy compression there used to reduce file size by 5% to 10% while providing sub-2 Å reconstruction) or uncompressed.

TIFF and MRC file formats may be used for high quality storage of image data. Similar to MRCs, TIFFs tend to be large in file size with 32-bit MRC and 32-bit TIFF image having similar or identical file sizes. For TIFFs, the disk space may be reduced using native compression.

The most common TIFF compressions are the Lempel-Ziv-Welch algorithm, or LZW, and ZIP compression. These strategies use codecs, or table-based lookup algorithms, that aim to reduce the size of the original image. Both LZW and ZIP are lossless compression methods and so will not degrade image quality. Two commonly used photography file formats that support up to 24-bit colour are PNG (Portable Network Graphics) and JPEG (Joint Photographic Experts Group). Electron micrographs typically are in grayscale so may be better suited to 8-bit file formats, which are also used in print media. PNG is a lossless file format and can utilize LZW compression similar to TIFF images. JPEG is a lossy file format that uses discrete cosine transform (DCT) to express a finite sequence of data points in terms of a sum of cosine functions. JPEG format may be avoided for archiving since quality may be lost upon each compression during processing. JPEG has a range of compression ratios ranging from JPEG100 with the least amount of information loss (corresponding to 60% of the original file size for the frame stack and 27% for the aligned sum image) to JPEG000 with the most amount of information loss (corresponding to 0.4% of the original file size for the frame stack and 0.4% for the aligned sum image).

In one example, the electron microscopy image is of size [M×N] pixels, wherein 240≤M, N≤10,000,000, preferably 1,000≤M, N≤5,000,000, more preferably 2,000≤M, N≤4,000,000.

TABLE 1
Example electron microscopy image of size [M × N] pixels.

| M | N |
|---|---|
| 320 | 240 |
| 640 | 480 |
| 1024 | 768 |
| 1280 | 1024 |
| 720 | 756 |
| 1280 | 720 |
| 1920 | 1080 |
| 4096 | 2160 |
| 3996 | 2160 |
| 4096 | 1716 |
| 3840 | 2160 |
| 7680 | 4320 |
| 3840 | 1644 |
| 3838 | 3710 |
| 7676 | 7420 |

For example, high resolution electron images may have sizes from [512×512] pixels to [10,000,000×10,000,000], depending on the stability of the electron microscope.

In one example, the electron microscopy image is grayscale, for example 8-bit, 16-bit, 24-bit or 32-bit, preferably 8-bit.

The method is implemented by the computer comprising the processor and the memory. Generally, the method may be performed using a single processor, such as an Intel (RTM) Core i3-3227U CPU@1.90 GHz or better, or multiple processors and/or GPUs. Suitable computers are known.

### Providing Set of Pre-Learned Dictionaries

The method comprises providing the set of pre-learned dictionaries, including the first pre-learned dictionary including the set of p₁ atoms. It should be understood that sparse coding is a representation learning method which aims at finding a sparse representation of the input data (also known as sparse coding) in the form of a linear combination of basic elements as well as those basic elements themselves. These elements are called atoms and they compose a dictionary. Atoms in the dictionary are not required to be orthogonal, and they may be an over-complete spanning set. This problem setup also allows the dimensionality of the signals being represented to be higher than the one of the signals being observed. These two properties lead to having seemingly redundant atoms that allow multiple representations of the same signal but also provide an improvement in sparsity and flexibility of the representation. In one example, the set of p₁ atoms includes p₁ atoms, wherein p₁ is in a range from 4 to 4096, preferably in a range from 16 to 2048, more preferably in a range from 64 to 1024, for example 128, 256 or 512.

In one example, the set of pre-learned dictionaries includes a second pre-learned dictionary comprising a set of p₂ atoms; and wherein reconstructing the electron microscopy image of the first sample using the sparse set of S sub-images of the first sample and the set of pre-learned dictionaries comprises reconstructing the electron microscopy image of the first sample using the sparse set of S sub-images of the first sample and a combination of the first pre-learned dictionary and the second pre-learned dictionary.

In this way, low frequency and high frequency features, for example, may be included in the first pre-learned dictionary and in the second pre-learned dictionary, respectively. The second pre-learned dictionary may be as described with respect to the first pre-learned dictionary mutatis mutandis.

In one example, the combination of the first pre-learned dictionary and the second pre-learned dictionary comprises and/or is a pair-wise combination of the first pre-learned dictionary and the second pre-learned dictionary.

In this way, respective atoms comprised in the first pre-learned dictionary and in the second pre-learned dictionary, respectively, may be combined, thereby improving a fidelity of reconstruction.

In one example, the method comprises training the first pre-learned dictionary using a set of training images, including a first training image, of a respective set of training samples, including a first training sample, wherein the set of training images excludes (i.e. does not include) the sparse set of S sub-images of the first sample and/or wherein the set of training samples excludes (i.e. does not include) the first sample. In this way, the first pre-learned dictionary is trained using one or more images different from images of the first sample.

In one example, the method comprises training the first pre-learned dictionary using the sparse set of S sub-images of the first sample. In this way, the first pre-learned dictionary is trained using the sparse set of S sub-images of the first sample.

In one example, the method comprises:
training the first pre-learned dictionary using a set of training images, including a first training image, of a respective set of training samples, including a first training sample, wherein the set of training images excludes (i.e. does not include) the sparse set of S sub-images of the first sample and/or wherein the set of training samples excludes (i.e. does not include) the first sample; and
training the first pre-learned dictionary using the sparse set of S sub-images of the first sample.

In this way, the first pre-learned dictionary is trained using one or more images different from images of the first sample and using the sparse set of S sub-images of the first sample. For example, the first pre-learned dictionary may be pre-trained using one or more images different from images of the first sample and further trained using the sparse set of S sub-images of the first sample.

In one example, providing the first pre-learned dictionary including the set of p₁ atoms comprises training a dictionary (i.e. the first pre-learned dictionary) using a fully sampled acquired electron microscopy image of a second sample and/or a fully sampled simulated electron microscopy image of the second sample. It should be understood that the fully sampled (i.e. 100%) acquired electron microscopy image of the second sample is acquired using electron microscopy and hence is a measured image, for example acquired using a detector of the electron microscope. In contrast, Compressive Sensing (CS) applied to STEM, for example, acquires a sub-sampled electron microscopy image, in which a sampling percentage is acquired through random scan points of the sample. See, for example, U.S. Pat. No. 20,190,43690A1, the subject matter of which is incorporated herein in entirety by reference. It should be understood that the fully sampled (i.e. 100%) simulated electron microscopy image of the second sample is computed (i.e. calculated by the computer) to correspond approximately with an acquired electron microscopy image of the second sample, in which the approximation is defined by the one or more target properties of the simulated electron microscopy image. In other words, the simulated electron microscopy image is a representation of the acquired electron microscopy image, having an acceptable quality for the intended application. That is, simulated electron microscopy image may be different from the acquired electron microscopy image but the differences are statistically and/or analytically acceptable.

In one example, the first sample and the second sample are mutually different. That is, the samples are different, for example of different materials.

In one example, a Structural Similarity Index (SSIM) of the reconstructed electron microscopy image calculated with respect to the fully sampled acquired electron microscopy image of the second sample and/or the fully sampled simulated electron microscopy image of the second sample is at most 60%, preferably at most 50%, more preferably at most 20%, most preferably at most 10%. In one example, a Structural Similarity Index (SSIM) of the reconstructed electron microscopy image calculated with respect to the fully sampled acquired electron microscopy image of the second sample and/or the fully sampled simulated electron microscopy image of the second sample is in a range from 0.01% to 60%, preferably in a range from 0.05% to 50%, more preferably in a range from 0.1% to 20%, most preferably in a range from 0.5% to 10%. Generally, the SSIM is a perceptual metric that quantifies the perceptual difference between two similar images, as described herein in more detail, and thus the perceptual difference between the reconstructed electron microscopy image and the image used for training the first pre-learned dictionary is relatively large. That is, these images are perceptually different.

In one example, a Peak Signal-to-Noise Ratio (PSNR) of the reconstructed electron microscopy image calculated with respect to the fully sampled acquired electron microscopy image of the second sample and/or the fully sampled simulated electron microscopy image of the second sample is at most 60%, preferably at most 50%, more preferably at most 20%, most preferably at most 10%. In one example, a Peak Signal-to-Noise Ratio (PSNR) of the reconstructed electron microscopy image calculated with respect to the fully sampled acquired electron microscopy image of the second sample and/or the fully sampled simulated electron microscopy image of the second sample is in a range from 0.01% to 60%, preferably in a range from 0.05% to 50%, more preferably in a range from 0.1% to 20%, most preferably in a range from 0.5% to 10%. PSNR estimates absolute error, as described herein in more detail, and thus the absolute error between the reconstructed electron microscopy image and the image used for training the first pre-learned dictionary is relatively large. That is, these images are perceptually different.

In one example, a mean squared error (MSE) of the reconstructed electron microscopy image calculated with respect to the fully sampled acquired electron microscopy image of the second sample and/or the fully sampled simulated electron microscopy image of the second sample is at most 60%, preferably at most 50%, more preferably at most 20%, most preferably at most 10%. In one example, a mean squared error (MSE) of the reconstructed electron microscopy image calculated with respect to the fully sampled acquired electron microscopy image of the second sample and/or the fully sampled simulated electron microscopy image of the second sample is in a range from 0.01% to 60%, preferably in a range from 0.05% to 50%, more preferably in a range from 0.1% to 20%, most preferably in a range from 0.5% to 10%. MSE estimates absolute error, as described herein in more detail, and thus the absolute error between the reconstructed electron microscopy image and the image used for training the first pre-learned dictionary is relatively large. That is, these images are perceptually different.

In one example, the method comprises transforming one or more atoms of the set of p₁ atoms included in the first pre-learned dictionary and/or the sparse set of S acquired sub-images. In one example, transforming comprises and/or is rotating, resizing, translating and/or applying a transformation matrix to the set of p₁ atoms included in the first pre-learned dictionary and/or to the sparse set of S sub-images.

### Acquiring Sparse Set of S Acquired Sub-Images

The method comprises acquiring, for example using an electron microscope, the sparse set of S acquired sub-images, including the first sub-image of size [a×b] pixels wherein a, b∈[2, min{M, N}], of the first sample.

It should be understood that the set of S acquired sub-images, including the first sub-image of size [a×b] pixels, is a sparse set, wherein the total area (and/or number of pixels) of the set of S acquired sub-images, including the first sub-image of size [a×b] pixels, is less than the area (and/or number of pixels) of the electron microscopy image of size [M×N] pixels. In one example, the total area (and/or number of pixels) of the set of S acquired sub-images, including the first sub-image of size [a×b] pixels, is in a range from 0.1% to 90%, preferable in a range from 1% to 75%, more preferably in a range from 10% to 50%, most preferably in a range from 15% to 35% of the area (and/or number of pixels) of the electron microscopy image of size [M×N] pixels.

It should be understood that S is a natural number. In one example, the set of S acquired sub-images includes S acquired sub-images, wherein S≥ 1, preferably wherein 1≤S≤10,000, more preferably wherein 10≤S≤5,000, most preferably wherein 100≤S≤1,000. In one example, each sub-image of the set of S acquired sub-images has a size [a×b] pixels. Preferably, the sub-images are the same size to maximise dispersion of sampling. In one example, each sub-image of the set of S acquired sub-images has a different size. In one example, the sub-images do not mutually overlap. In one example, at least some of the sub-images mutually overlap. Preferably, the sub-images do not mutually overlap since mutual overlapping decreases the efficiency and sparsity. In one example, the sub-images are not mutually adjacent. In one example, at least some of the sub-images are mutually adjacent.

Preferably, the sub-images are not mutually adjacent since mutual adjacency decreases the efficiency and sparsity.

It should be understood that a, b are natural numbers. In one example, a=b. In one example, a+b. In one example, 2≤a, b≤10, preferably 2≤a, b≤5, more preferably 2≤a, b≤3. In one preferred example, a=b=2.

### Reconstructing the Electron Microscopy Image

The method comprises reconstructing the electron microscopy image of the first sample using the sparse set of S sub-images of the first sample and the set of pre-learned dictionaries.

In one example, reconstructing the electron microscopy image of the first sample using the sparse set of S sub-images of the first sample and the set of pre-learned dictionaries comprises reconstructing the electron microscopy image of the first sample using the sparse set of S sub-images of the first sample and the set of pre-learned dictionaries according to a target property and/or a respective threshold thereof.

In one example, the target property of the reconstructed electron microscopy image is a Structural Similarity Index (SSIM) and the respective threshold thereof is at least 60%, preferably at least 70%, more preferably at least 80%, most preferably at least 90%. Generally, the SSIM is a perceptual metric that quantifies the perceptual difference between two similar images, for example image quality degradation caused by processing such as data compression or by losses in data transmission. As applied to the method according to the first aspect, the perceptual difference results from approximation of the reconstruction, according to the obtained respective thresholds of the one or more target properties of the reconstructed electron microscopy image. The SSIM is a full reference metric that requires two images from the same image capture: a reference image and a processed image. As applied to the method according to the first aspect, the reference image is thus an ideal or quasi-ideal reconstructed electron microscopy image, computed according to the target properties of the reconstructed electron microscopy image (i.e. exact, without permissible thresholds) or an acquired electron microscopy image while the processed image is the reconstructed electron microscopy image computed according to the obtained respective thresholds of the one or more target properties of the reconstructed electron reconstructed image. It should be understood that a reference image is not provided for each reconstructed electron microscopy image; rather, reference images are provided for representative reconstructed electron microscopy images and the computing thereof to achieve the respective thresholds of the one or more target properties applied to computing of other reconstructed electron microscopy images. In other words, the required computing so as to achieve the respective thresholds of the one or more target properties is learned.

In one example, the target property of the reconstructed electron microscopy image is a Peak Signal-to-Noise Ratio (PSNR) and the respective threshold thereof is at least 60%, preferably at least 70%, more preferably at least 80%, most preferably at least 90%. PSNR estimates absolute error. PSNR is usually expressed as a logarithmic quantity using the decibel scale. PSNR is commonly used to measure the quality of reconstruction of lossy compression codecs (e.g., for image compression).

In one example, the target property of the reconstructed electron microscopy image is a mean squared error (MSE) and the respective threshold thereof is at least 60%, preferably at least 70%, more preferably at least 80%, most preferably at least 90%. MSE estimates absolute error. As MSE is derived from the square of Euclidean distance, the MSE is always a positive value with the error decreasing as the error approaches zero. MSE may be used either to assess a quality of a predictor (i.e. a function mapping arbitrary inputs to a sample of values of some random variable), or of an estimator (i.e. a mathematical function mapping a sample of data to an estimate of a parameter of the population from which the data is sampled).

PSNR and MSE both estimate absolute errors. In contrast, SSIM accounts for the strong interdependencies between pixels, especially closely-spaced pixels. These inter-dependencies carry important information about the structure of the objects in the image. For example, luminance masking is a phenomenon whereby image distortions tend to be less visible in bright regions, while contrast masking is a phenomenon whereby distortions become less visible where there is significant activity or “texture” in the image. Hence, SSIM is preferred.

Resolution and sensitivity/contrast were previously standard STEM image quality metrics but are subjective, being dependent on where measured. Hence, PSNR, MSE and SSIM are preferred. Other quality metrics, including those not requiring a reference, are under development and may be applied mutatis mutandis.

In one example, reconstructing the electron microscopy image of the first sample using the sparse set of S sub-images of the first sample and the set of pre-learned dictionaries comprises reconstructing the electron microscopy image of the first sample using the sparse set of S sub-images of the first sample and the first pre-learned dictionary trained using the using the sparse set of S sub-images of the first sample.

In one example, the method comprises selecting a subset of p′₁ atoms from the set of p₁ atoms included in the first pre-learned dictionary; and wherein reconstructing the electron microscopy image of the first sample using the sparse set of S sub-images of the first sample and the set of pre-learned dictionaries comprises reconstructing the electron microscopy image of the first sample using, for example only using, the sparse set of S sub-images of the first sample and the selected subset of p′₁ atoms included in the first pre-learned dictionary.

In this way, the method according to the first aspect provides a method of adaptive dictionary element selection, in which undesired atoms are pruned (i.e. removed) from the first pre-learned dictionary, thereby increasing an efficiency of reconstructing the electron microscopy image of the first sample while not adversely affecting a quality thereof.

In one example, selecting the subset of p′₁ atoms from the set of p₁ atoms included in the first pre-learned dictionary comprises selecting the subset of p′₁ atoms from the set of p₁ atoms included in the first pre-learned dictionary based on residual energies of the respective atoms of the set of p₁ atoms, for example wherein respective atoms of the subset of p′₁ atoms have respective energies of at most or of at least a threshold residual energy.

In this way, the subset of p′₁ atoms are selected from the set of p₁ atoms based on the residual energies of the respective atoms of the set of p₁ atoms, for example to reduce and/or minimise affecting a quality of the reconstructed image.

### Inpainting

In one example, reconstructing the electron microscopy image of the first sample using the sparse set of S sub-images of the first sample and the selected subset of p′₁ atoms included in the first pre-learned dictionary comprises inpainting. For example, an inpainting algorithm may be used to fill in gaps in the sub-sampled data, with missing information inferred from the sub-sampled data through a combination of a dictionary learning algorithm and a sparsity pursuit algorithm. A common class of inpainting algorithms involve sparse dictionary learning. Dictionary learning algorithms produce a dictionary of basic signal patterns, which is learned from the data, which is able to via a sparse linear combination with a set of corresponding weights. This dictionary is then used in conjunction with a sparse pursuit algorithm to inpaint the pixels of each overlapping patch which when combined form a full image.

### Controlling an Electron Microscope

The second aspect provides a method of controlling an electron microscope, the method implemented, at least in part, by a computer comprising a processor and a memory, the method comprising:
obtaining parameters of the electron microscopy;
acquiring a first sparse set of S acquired sub-images of a first sample comprising controlling the electron microscope using the obtained parameters of the electron microscopy;
reconstructing a first electron microscopy image of size [M×N] pixels of the first sample according to the first aspect and/or the sixth aspect using the first sparse set of S sub-images of the first sample;
comparing the first electron microscopy image against thresholds of one or more target properties of the first electron microscopy image;

adapting the parameters of the electron microscopy based on a result of the comparing; and acquiring a second sparse set of S acquired sub-images of the first sample comprising controlling the electron microscope using the adapted parameters of the electron microscopy.

In this way, the reconstructed image of the first sample is used to adapt, for example optimise, the parameters of the electron microscopy in silico before subsequently acquiring the image of the second sample using the electron microscope. In this way, a duty cycle of the electron microscope and/or a quality of the acquired image may be enhanced while damage to the sample reduced.

The method comprises comparing the first electron microscopy image against the thresholds of one or more target properties of the first electron microscopy image, for example for validation thereof. Validation mitigates aberrations and/or artefacts due to the electron microscopy, for example due to incorrect parameters of the electron microscopy, operational errors and/or peculiarities of the sample. Optionally, based on a result of the comparing, the parameters of the electron microscope are adapted and the second acquired image of the sample is acquired, using the adapted parameters. That is, the parameters of the electron microscope are optimised or refined for the sample. In this way a quality of the second acquired image may be further enhanced while damage to the sample controlled.

In one example, adapting the parameters of the electron microscopy based on a result of the comparing comprises:
adapting, for example iteratively, recursively and/or repeatedly, the parameters of the electron microscopy, attributes of the sample and/or respective thresholds of the one or more target properties of the first electron microscopy image; and
reconstructing the first electron microscopy image of size [M×N] pixels of the first sample using the updated parameters of the electron microscopy and/or the adapted attributes of the first sample, according to the updated respective thresholds of the one or more target properties of the simulated electron microscopy image.

In this way, the second electron microscopy image is optimised since the parameters of the electron microscopy, the attributes of the sample and/or the respective thresholds of the one or more target properties of the electron microscopy image are updated, for example iteratively, recursively and/or repeatedly, so as to improve the quality of the second electron microscopy image within the respective thresholds of the one or more target properties and/or within a computer resource budget, as described previously.

It should be understood that the acquired image of the sample is a measured image, for example acquired using a detector of the electron microscope.

In one example, the method comprises: reconstructing a second electron microscopy image of size [M×N] pixels of the first sample according to the first aspect and/or the sixth aspect using the second sparse set of S sub-images of the first sample.

### Parameters of Electron Microscopy

The method comprises obtaining parameters (also known as settings or acquisition parameters) of the electron microscopy. In this way, the simulated electron microscopy image is computed to correspond with an acquired electron microscopy image of the sample. In one example, the parameters include: accelerating voltage, circle aberration coefficient Cs (which determines beam size), ADF detector or equivalent. Other parameters are known. In one example, the parameters additionally and/or alternatively include: condenser lens parameter (for example source spread function, defocus spread function and/or zero defocus reference) and/or objective lens parameters (for example source spread function, defocus spread function and/or zero defocus reference). It should be understood that particular electron microscopes implement particular parameters, subsets and/or combinations thereof.

### Attributes of Sample

Generally, the attributes are and/or represent physical and/or chemical characteristics of the sample. In one example, the attributes include chemical composition, structure, crystallography, lattice parameters, thickness, orientation with respect to electron beam and/or microstructure. Other attributes are known. For example, examples of other attributes include, but are not limited to, regional intensity maxima, edges, periodicity, regional chemical composition, or combinations thereof. For example, intensity maxima in the image data may represent peaks associated with particles, molecules, and/or atoms. Edges in the image data may represent particle boundaries, grain boundaries, crystalline dislocations, stress/strain boundaries, interfaces between different compositions/crystalline structures, and combinations thereof. Periodicity in the image data may be related to crystallinity and/or patterned objects. Computational analysis may be performed on the image data including, but are not limited to, a theoretically optimal sparsifying transform technique, an edge detection technique, a Gaussian mixture regression technique, a summary statistics technique, a measures of spatial variability technique, an entropy technique, a matrix decomposition information technique, a peak finding technique, or a combination thereof. Typically, the sample has a thickness of 1 to 20 unit cells. Generally, a patch is at least 2×2 pixels. In one example, the sample is crystalline. In one example, the sample is non-crystalline e.g. amorphous. Non-crystalline samples may be simulated mutatis mutandis.

### Computer, Computer Program, Non-Transient Computer-Readable Storage Medium

The third aspect provides a computer comprising a processor and a memory configured to implement a method according to any of the first aspect and/or the second aspect and/or the sixth aspect, a computer program comprising instructions which, when executed by a computer comprising a processor and a memory, cause the computer to perform a method according to any of the first aspect and/or the second aspect and/or the sixth aspect or a non-transient computer-readable storage medium comprising instructions which, when executed by a computer comprising a processor and a memory, cause the computer to perform a method according to any of the first aspect and/or the second aspect and/or the sixth aspect.

### Electron Microscope

The fourth aspect provides an electron microscope including a computer comprising a processor and a memory configured to implement a method according to any of the first aspect and/or the second aspect and/or the sixth aspect.

### Use

The fifth aspect provides use of a pre-learned dictionary in reconstructing an electron microscopy image of a sample.

### Real-Time Dictionary Transfer

The sixth aspect provides a method of real-time dictionary transfer, the method implemented by a computer comprising a processor and a memory, the method comprising:
initialising an initial dictionary D₀, for example wherein the initial dictionary is generated randomly or imported such as from a previous result, with parameters governing dimensionality and/or sparsity of the dictionary and/or Bayesian priors, for example denoting respective probabilities of element selection, noise variance, etc.;
initialising a first instance of BPFA with a transfer source Y₀ (i.e. a first input source such as a training image), wherein the first instance of BPFA comprises and/or is a training instance I₀ of BPFA, for example wherein the training instance I₀ of BPFA takes the transfer source Y₀ to be transferred from as an input thereof, having a first connection, for example a shared connection, to a transient dictionary Dₜ derived from the initial dictionary D₀;
initialising a second instance of BPFA with a target source Y₁ (i.e. a second input source such as a subsampled image to be inpainted), wherein the transfer source Y₀ and the target source Y₁ are mutually different, wherein the second instance of BPFA comprises and/or is a reconstruction instance I₁ of BPFA, for example wherein the reconstruction instance I₁ of BPFA takes an image to be transferred to as an input thereof, having a second connection, for example a shared connection, to the transient dictionary Dₜ (i.e. the same transient dictionary Dₜ);
performing one or more training iterations and reconstruction iterations (also known as loops), for example serially (i.e. sequentially, consecutively, alternately) and/or in parallel (i.e. simultaneously, concurrently), using the first instance of BPFA and the second instance of BPFA, respectively, comprising, for each respective training iteration and reconstruction iteration:
   updating, by the first instance of BPFA (i.e. the training instance lo of BPFA) during the training iteration (for example, during each training iteration), pixels of the transient dictionary Dₜ (and optionally, statistical parameters thereof, for example π, γ_{ϵ}, γ_{d}, γ_{ω}), whereby the transient dictionary Dₜ learns the features of the transfer source Y₀; and
   updating, by the second instance of BPFA (i.e. the reconstruction instance I₁ of BPFA) during the reconstruction iteration (for example, during each reconstruction iteration), statistical parameters, for example π, γ_{ϵ}, γ_{d}, γ_{ω}) of the transient dictionary Dₜ, whereby the transient dictionary Dₜ converges, for example after a plurality of iterations (also known as repeats or repetitions), thereby containing features of the transfer source Y₀ and/or selection probabilities (such as BPFA priors/parameters) governed by the target source Y₁; and
producing, using the transient dictionary Dₜ, a visualisation [symbol] , representing a reconstruction of the target source Y₁ (i.e. reconstructing a visualisation [symbol] of the target source Y₁ using the transient dictionary Dₜ).

In this way, the method provides real-time dictionary transfer, for example for real-time CS-STEM as described herein. The visualisation [symbol] , representing the reconstruction of the target source Y₁, is a product of the transient dictionary Dₜ, learned from the transfer source Y₀, and the appropriate coefficients determined by the reconstruction instance I₁ of BPFA, thereby providing real-time dictionary transfer.

The method according to the sixth aspect may include any step and/or feature as described with respect to the first aspect and/or the second aspect.

More simply:

The sixth aspect provides a method of real-time dictionary transfer, the method implemented by a computer comprising a processor and a memory, the method comprising:
initialising an initial dictionary D₀;
initialising a first instance of BPFA with a transfer source Y₀, wherein the first instance of BPFA comprises and/or is a training instance I₀ of BPFA, having a first connection to a transient dictionary Dₜ derived from the initial dictionary D₀;
initialising a second instance of BPFA with a target source Y₁, wherein the transfer source Y₀ and the target source Y₁ are mutually different, wherein the second instance of BPFA comprises and/or is a reconstruction instance I₁ of BPFA, having a second connection, for example a shared connection, to the transient dictionary Dₜ;
performing one or more training iterations and reconstruction iterations, using the first instance of BPFA and the second instance of BPFA, respectively, comprising, for each respective training iteration and reconstruction iteration:
   updating, by the first instance of BPFA during the training iteration, pixels of the transient dictionary Dₜ, whereby the transient dictionary Dₜ learns the features of the transfer source Y₀; and
   updating, by the second instance of BPFA during the reconstruction iteration, statistical parameters of the transient dictionary Dₜ, whereby the transient dictionary Dₜ converges, thereby containing features of the transfer source Y₀ and selection probabilities governed by the target source Y₁; and
producing, using the transient dictionary Dₜ, a visualisation [symbol] , representing a reconstruction of the target source Y₁.

More generally:

The sixth aspect provides a method of real-time dictionary transfer, the method implemented by a computer comprising a processor and a memory, the method comprising:
initialising a training instance I₀ of BPFA with a transfer source Y₀, having a first connection to a transient dictionary Dₜ;
initialising a reconstruction instance I₁ of BPFA with a target source Y₁, wherein the transfer source Y₀ and the target source Y₁ are mutually different, having a second connection to the transient dictionary Dₜ;
performing one or more training iterations and reconstruction iterations, using the training instance I₀ of BPFA and the reconstruction instance I₁ of BPFA, respectively, comprising, for each respective training iteration and reconstruction iteration:
   updating, by the training instance I₀ of BPFA during the training iteration, pixels of the transient dictionary Dₜ; and
   updating, by the reconstruction instance I₁ of BPFA during the reconstruction iteration, statistical parameters of the transient dictionary Dₜ; and
reconstructing a visualisation [symbol] of the target source Y₁ using the transient dictionary Dₜ.

During initialization, the following parameters are set and are not altered by either instance of BPFA:
K: Size of the dictionary/No. of elements [governs dimensionality]
B: Shape of the dictionary elements/patches [governs dimensionality]
πₐ, π_{b}: (shown as a, b in FIG. 13B): Hyper-parameters [governs element sparsity]

The following parameters are related to the statistical properties of the BPFA algorithm and are updated by BOTH instances (i.e. the reconstruction instance continues to fit the statistical parameters to the subsampled input, despite not affecting the dictionary elements themselves):
π also shown as πₖ: Bayesian prior, essentially a measure of the global probability of selection for a given dictionary element.
γ_{ω}: Precision of the weights/coefficients [shown in in FIG. 13B]
γ_{ϵ}: Precision of the noise [shown as γₙ, in FIG. 13B]γ_{d}: Precision of the dictionary elements [not shown in in FIG. 13B]

The initial dictionary is just used to initialise a transient dictionary Dₜ, it could be totally randomly generated, be some form of transform dictionary e.g. DCT, in both cases, parameters are initialised to default values. Additionally, it could be loaded back in from previous experiments (along with its parameters).

In the case of reconstructing a single image (where the pixel values of the image are constant), then a dictionary will converge to a final solution and the changes to the dictionary upon each update will tend to zero, at this point we may stop training and consider it a final dictionary. However, this form of using a transient dictionary, as showed in the flow chart if FIG. 13A, is really designed for a time-variable input feed, i.e. a subsampled target such as the target source Y₁, which is constantly changing, such as the output feed of an electron microscope, or a webcam. In this case, as the features of the image are continuously changing, the dictionary will continue to learn features and evolve to account for new information indefinitely, until we stop the process of viewing the reconstruction in real-time.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 shows K-SVD [16×16] dictionaries (generated using MATLAB) for all four input images, showing the varying features learned from each image. PSNR values shown correspond to a fully sampled (100%) reconstruction of the source image using the given dictionary.

FIG. 2 shows reconstructions of the images ‘Barbara’ and ‘Atomic’ using their two corresponding dictionaries. Highlighted images along the diagonal show images inpainted with their own dictionaries. PSNR values are measured against the reference image (left).

FIG. 3 shows an illustration of the formation of a [16×16] patch (centered atom from the image ‘Atomic’) inpainted with (non-circular) dictionary atoms from the image ‘Barbara’ showing the cumulative combination of dictionary elements. Sparse coding was performed with a custom OMP implementation in python.

FIG. 4 shows K-SVD [16×16] dictionaries (generated using MATLAB) for all magnifications, showing the varying features learned from each image. PSNR values shown correspond to a fully sampled (100%) reconstruction of the source image using the given dictionary.

FIG. 5 shows 25% (cropped) reconstructions of heat-treated Ceria using 3M and 12M magnifications, showing a reduced reconstruction quality when using inappropriately ‘scaled’ dictionary elements. Highlighted images along the diagonal show images inpainted with their own dictionaries. PSNR values are measured against the reference image (left).

FIG. 6 shows a grid of 25% reconstructions of the 4 input images (top) using dictionaries generated from the references (left). Highlighted images along the diagonal show images inpainted with their own dictionaries. PSNR values are measured against the reference image (left).

FIG. 7 is a table of PSNR values for the transfer experiment. Colour bars are scaled according to input images (columns).

FIG. 8 is a table of SSIM values for the transfer experiment. Colour bars are scaled according to input images (columns).

FIG. 9 shows a grid of 25% reconstructions of all images at different magnifications using dictionaries generated from the references (left). Highlighted images along the diagonal show images inpainted with their own dictionaries. PSNR values are measured against the reference image (left).

FIG. 10 is a table of PSNR values for the magnification experiment. Colour bars are scaled according to input images (columns).

FIG. 11 is a Table of SSIM values for the magnification experiment. Colour bars are scaled according to input images (columns).

FIG. 12A schematically depicts traditional reconstruction (single instance); FIG. 12B schematically depicts an example of dual-instance configuration; FIG. 12C schematically depicts frame-by-frame reconstruction; and FIG. 12D schematically depicts data visualisation.

FIG. 13A schematically depicts a new method for real-time dictionary transfer according to an exemplary embodiment, using separate training and reconstruction instances of BPFA (each with their own set of parameters and coefficients) operating on the same transient dictionary Dₜ; and FIG. 13B shows definitions of parameters for the method of FIG. 13A.

FIG. 14 shows image reconstruction quality results (against sampling %) for an atomic-resolution image using a static 2D DCT Dictionary, a pre-trained dictionary at 100% sampling (i.e. using dictionary transfer from the reference) and a subsampled dictionary trained at each of the sampling ratios.

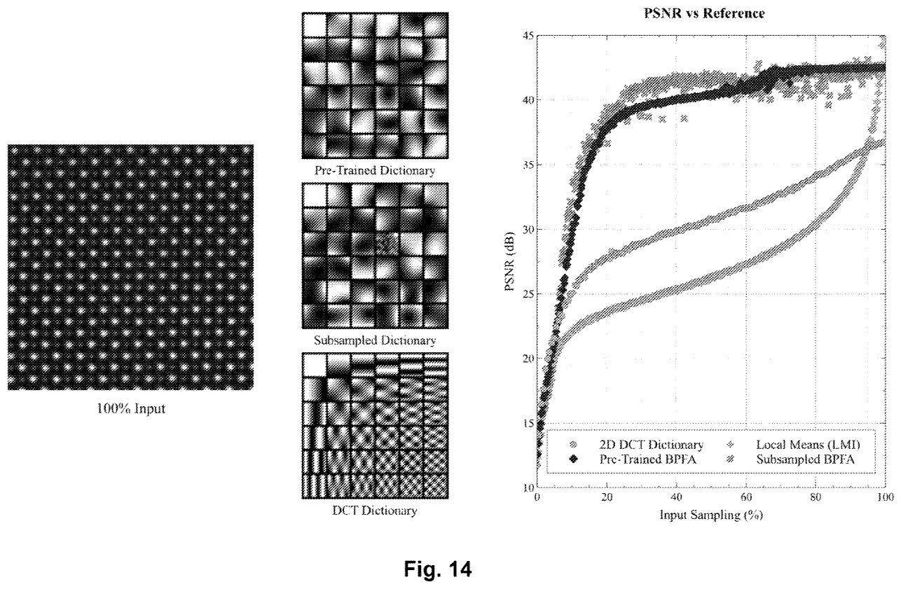

FIG. 15 shows image reconstruction quality results (against sampling %) for a natural (test) image using a static 2D DCT Dictionary, a pre-trained dictionary at 100% sampling (i.e. using dictionary transfer from the reference) and a subsampled dictionary trained at each of the sampling ratios.

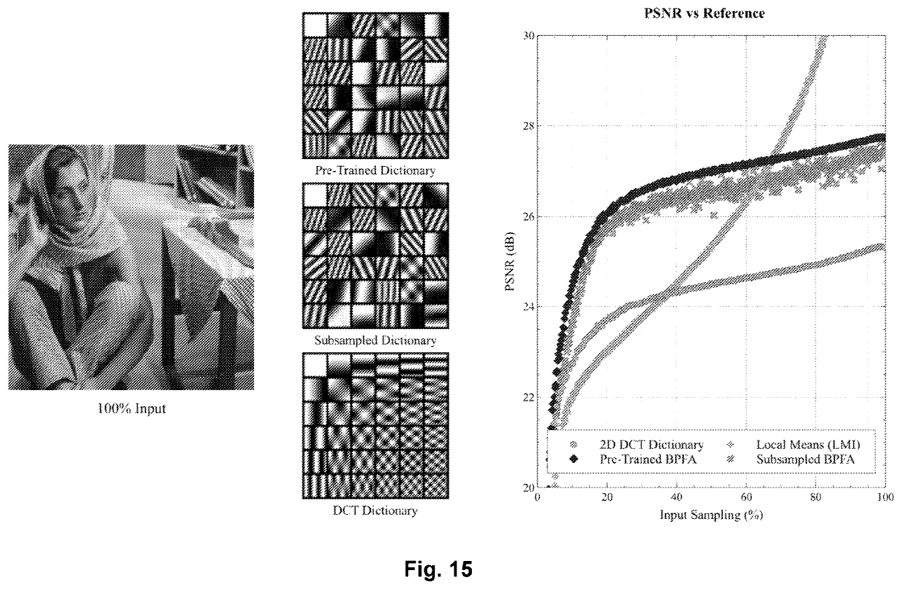

FIG. 16 shows generic dictionary transfer results for a set of various images (some natural, some STEM), showing the quality of reconstructions of each of the images with each corresponding BPFA dictionary.

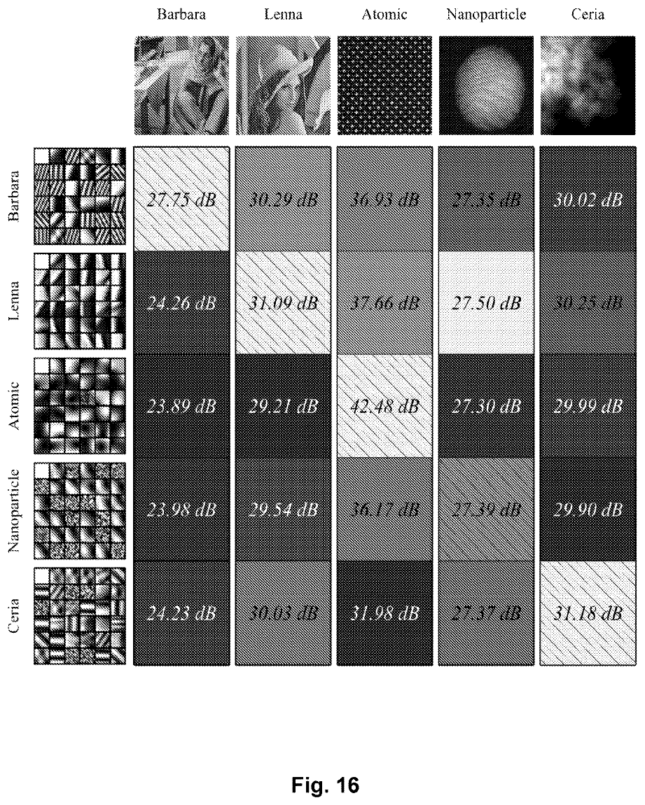

FIG. 17 shows generic dictionary transfer results for a series of STEM images of High Resolution Ceria at various magnifications, showing the quality of reconstructions of each of the images with each corresponding BPFA dictionary.

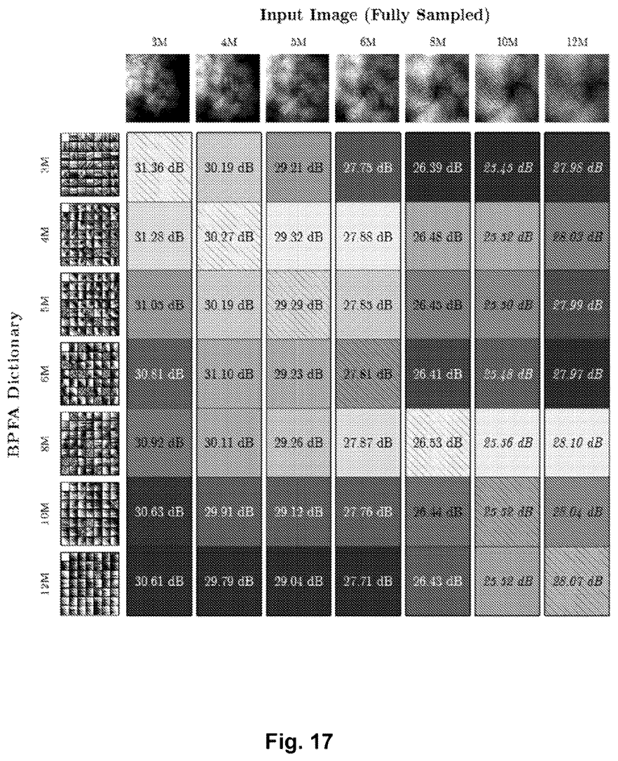

FIG. 18 shows (Both) Plot of PSNR (dB) quality metric against time-to-solution(s) for a 25% subsampled image of high-resolution Ceria (8M) comparing the use of a dictionary pre-trained on the target image at 100% sampling (“Dictionary Transfer”) against learning a dictionary directly from the subsampled frame (“Subsampled Training”). Each data-point represents a batch (¼ of the dataset) averaged over 10 independent trials. As shown in FIG. 18, dictionary transfer (from 100% reference) is capable of producing an improved reconstruction for multiple epochs, due to the time required for the dictionary to converge when training directly from subsampled data. In a real-time reconstruction scenario (where each ‘frame’ may only be reconstructed for 1-2 epochs) this provides a significant advantage, essentially allowing for an equivalent reconstruction in a fraction of the time.

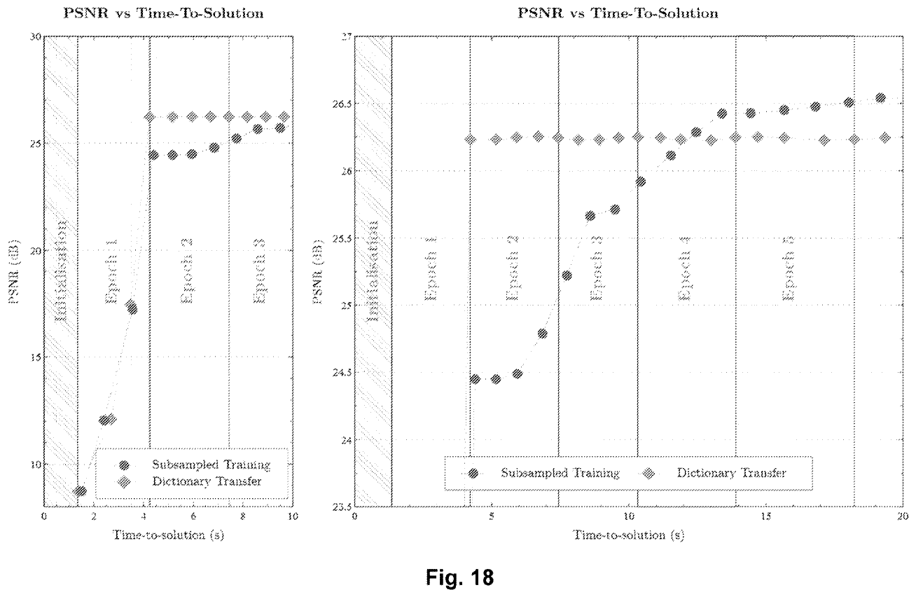

FIG. 19 shows: (Top, left) Input sub-sampled data with 2% sparse acquisition. Inpainting using sparse dictionary learning and reconstruction are shown in top right. (Bottom, left) Simulated image of the same sample. Inpainting of input using the dictionary learnt from the simulated data, shown in bottom right. The result shows a superior reconstruction by using a dictionary from a simulated image.

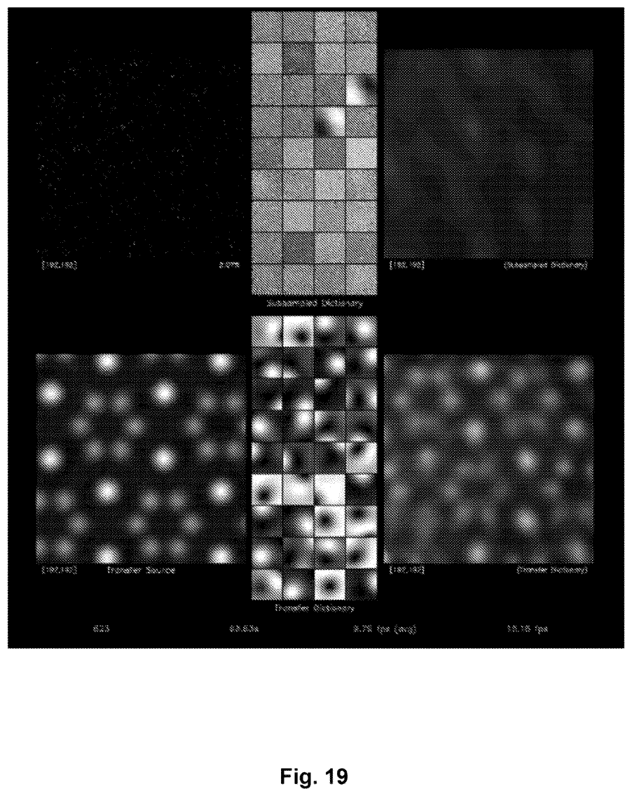

FIG. 20 shows: (Left) Input sub-sampled experimental data inpainted using BPFA trained on the sparse sampled input, (right) same sample as left but this time it is inpainted using a dictionary from simulated data. The results show a super-resolved image where the higher frequencies in the power-spectra (overlaid) are transferred from the simulated data.

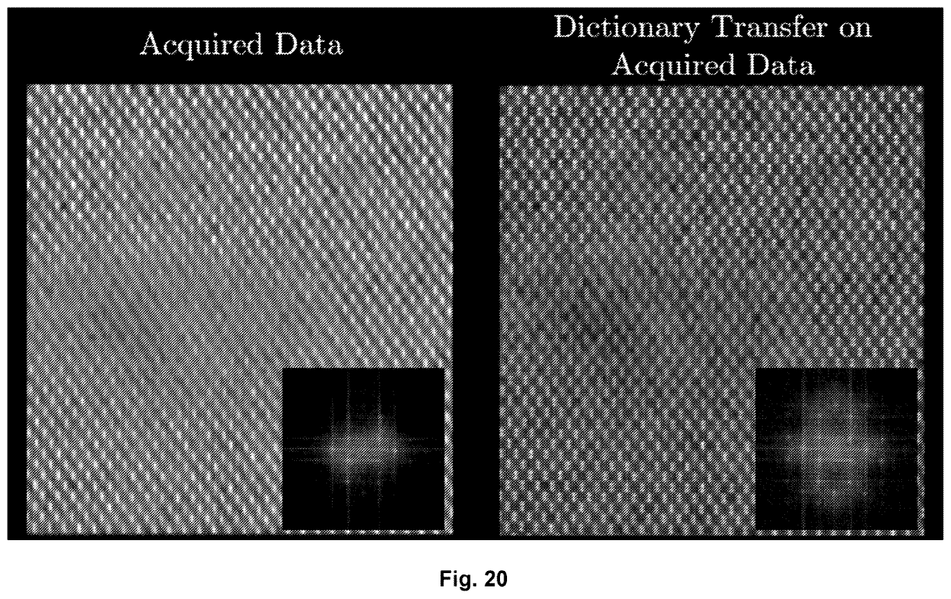

### DETAILED DESCRIPTION OF THE DRAWINGS

While the main goal of this research is to investigate the application of these methods to subsampled acquisition, particularly for materials which may not currently be imaged, the general cross-compatibility of representative dictionaries applies to those trained on fully-sampled data, and sub-sampled data alike. For simplicity, and the ease of reproducing our results, the following experiments use dictionaries trained on fully-sampled images. All reconstructions in this paper therefore used K-SVD (performed in MATLAB using ksvdbox13) to generate a representative dictionary from a fully sampled image, which were then artificially subsampled (randomly, to 25%) and reconstructed using OMP (via a custom OpenMP, CPU parallelised C⁺⁺ implementation). For consistency, all dictionaries were the same size (128 elements) and were trained with the same parameters.

### Experiment 1: Dictionary Transfer

The concept of dictionary transfer is simple; learning a dictionary from one image (whether that be fully sampled or not) and using it to inpaint another subsampled image. One may initially suspect that if the two images are very different, this process would lead to a very poor reconstruction. However, due to the nature of a sparse linear combination of dictionary elements, widely varying signals may be represented with different combinations (and weights) of only a few atoms. The benefit of this is clear, if a pre-learned dictionary is capable of generating a reasonable quality reconstruction of any given (potential) STEM image, a fully sampled ‘live’ preview of the sample may be reconstructed in minimal time (either with a significantly reduced dictionary learning step for untrained materials, or taking only the time required for the sparse-coding step for materials the dictionary is known to be appropriate for), allowing for the spatial position, magnification and more to be fine-tuned by the microscope operator before a final scan is taken. To test the feasibility of dictionary transfer, we perform an experiment on four different images, the first of which is an example of a ‘natural’ image (photograph) for comparison, and the following three of which are HAADF STEM images:

| | |
|---|---|
| ‘Barbara’ | A publicly available test image. |
| ‘Ceria’ | A high resolution image of heat-treated ceria |
| | (acquired with a JEOL 2100F Cs-corrected |
| | STEM) |
| ‘Atomic’ | An atomic resolution image selected from |
| | the Warwick STEM dataset |
| ‘Nanoparticle’ | A high-resolution image of a nanoparticle |
| | (with atomic resolution) |
| | selected from the Warwick STEM dataset |

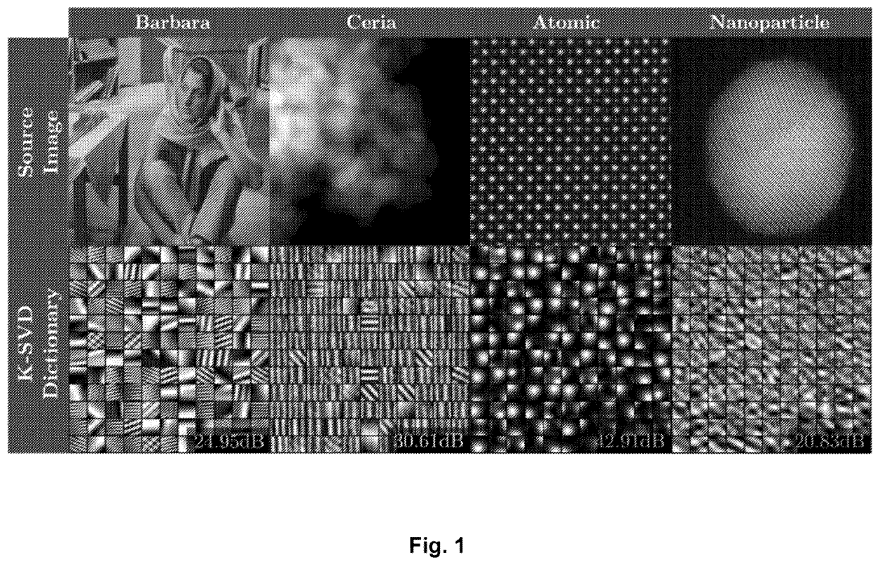

FIG. 1 shows the K-SVD generated dictionaries with elements of size [16×16] for each of the different images, containing very different elements in order to reconstruct the corresponding image features; such as the dictionary generated from the ‘Atomic’ labelled image, which is composed of circles (atoms) in varying positions within the patch, and that of ‘Barbara’ containing the characteristic gradients, stripes and checkerboard patterns common in the test image.

As can be seen above, whilst the ‘natural’ image ‘Barbara’ produced a wide range of dictionary elements with varying patterns, the STEM images all produced significantly less varied dictionaries, with many atoms appearing similar. This suggests that whilst the dictionary size of 128 atoms chosen to for the experiment was appropriate for ‘Barbara’, it is seemingly too large for the three STEM images, which appear to have over-fitted dictionaries; Each of the STEM may be reconstructed to a similar quality with many fewer dictionary elements than are present, due to the reduced variety of signal patterns contained within STEM images. Clearly, if this is the case for a wide range of STEM images, the requirement for fewer atoms may be exploited in the quest for ‘real-time’ reconstructions, as the time-to-solution for many of the aforementioned sparse-coding (and dictionary learning) algorithms significantly depend on the dictionary size. Additionally, if the types of signal patterns present in most STEM images require fewer dictionary elements to be accurately reconstructed, the plausibility of a ‘master’ dictionary able to inpaint STEM images in most scenarios without becoming prohibitively large increases.

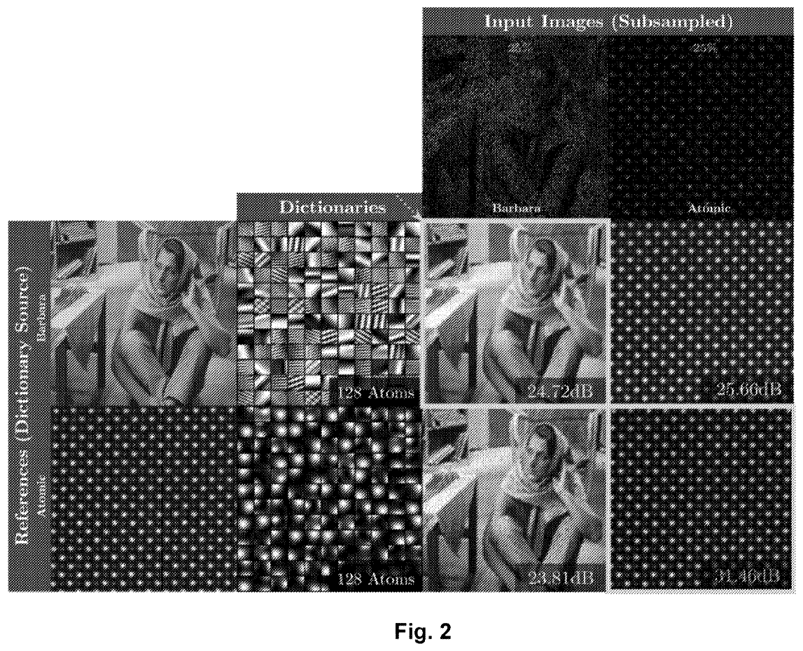

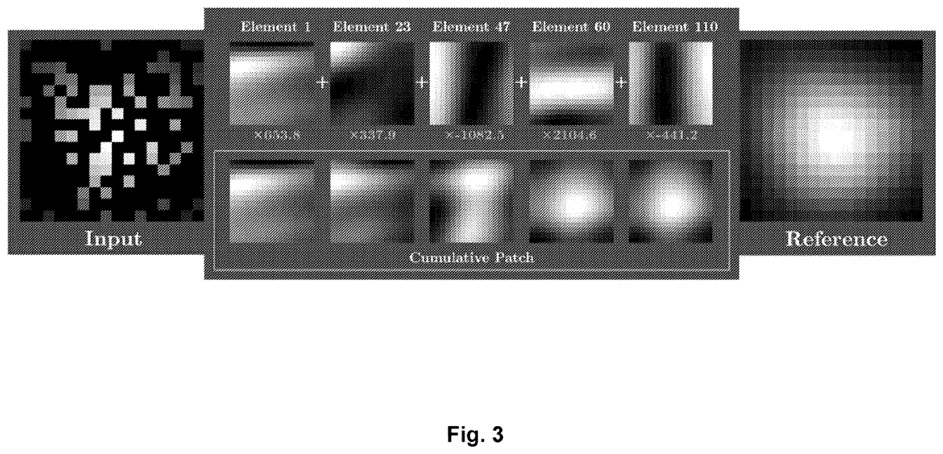

In FIG. 2, we show the subsampled reconstructions of the images ‘Barbara’ and ‘Atomic’ using both generated dictionaries. As expected, the best images arise on the ‘diagonal’ i.e. where the image was inpainted using the atoms trained on its corresponding (fully-sampled) reference image. In the ‘off-diagonal’ cases, while the reconstruction is successful (i.e. low-frequency/large-scale details are recovered), fine details are lost, such as the stripes in Barbara's clothing and the tablecloth, despite the reasonably high PSNR metric when compared with the ‘diagonal’ case. In the case of using the ‘Atomic’ dictionary to reconstruct ‘Barbara’, significant noise is also incurred, with artefacts appearing as circular spots visible in the reconstruction. Despite this, however, the results are encouraging, especially in the case of using the dictionary elements learned from ‘Barbara’ to reconstruct the ‘Atomic’ image. As shown in FIG. 3, the elements of the ‘Barbara’ dictionary contain no ‘circular’ atoms but are able to combine together to form a surprisingly accurate approximation of a given reference patch of the ‘Atomic’ image. This suggests that a ‘master’ dictionary with optimised elements (trained to maximally represent a large database of STEM images) may be able to quickly reconstruct a much wider range of signal patterns than one may initially suspect, from simple lines such as atomic planes, to much more complex shapes.

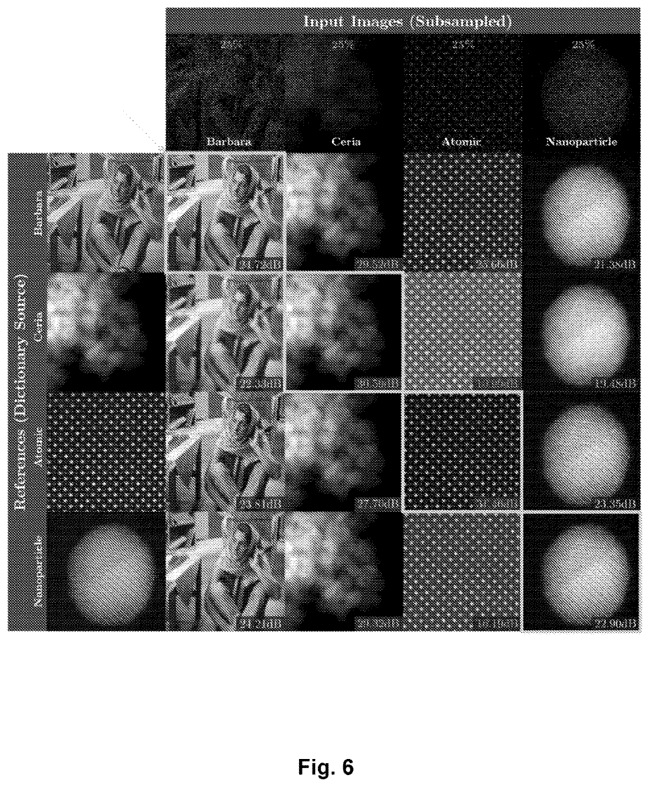

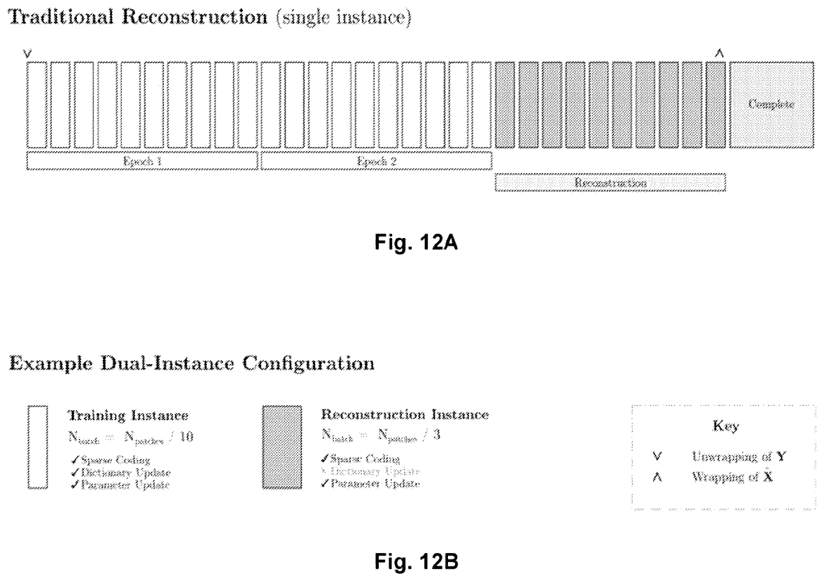

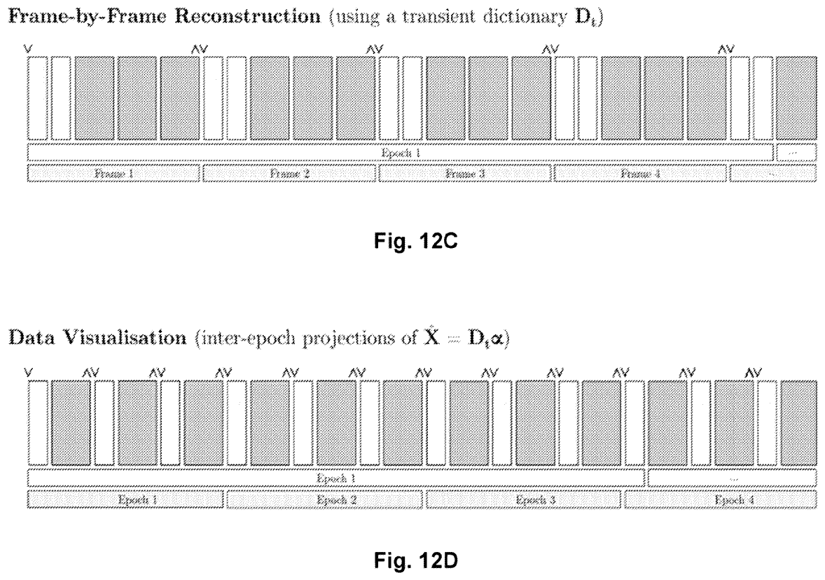

As illustrated in FIG. 3, a linear combination of weights and seemingly inappropriate dictionary elements from the image ‘Barbara’ cumulatively form a reconstructed patch which iteratively approximates the ‘true’ reference patch, shown on the right. For the full results of this experiment, including all images reconstructed with each dictionary along with the PSNR and SSIM quality metrics, see FIGS. 6 to 11 and the corresponding description.

### Experiment 2: Magnification/Feature Size

For STEM images, as well as considering the different features of various potential materials one may wish to represent with a given dictionary, the microscope adds many other factors which significantly change the visual appearance of the sample, such as the chosen detector (ABF/HAADF), focus conditions and magnification. Any successful ‘master’ dictionary used to inpaint the live output of a microscope must also be able to account for these microscope conditions, the most demonstrable of which is magnification, as even the same sample of material may appear vastly different at high and low magnification. Intuitively, the size of the features (in any given [16×16] patch) for each image is different; for low magnification such as 3M, clusters of nanoparticles form a rough topography with fine details only in the form of atomic planes (represented in the dictionary with elements containing alternating horizontal stripes), whereas in the 12M image, fine details are drastically different as atomic columns are clearly resolved, forming many unique shapes on a much smaller scale.

In this experiment, we test the cross-compatibility of dictionaries generated for the same sample of high-resolution heat-treated Ceria at 7 different magnifications from 3M to 12M acquired with a JEOL 2100F Cs-corrected STEM.

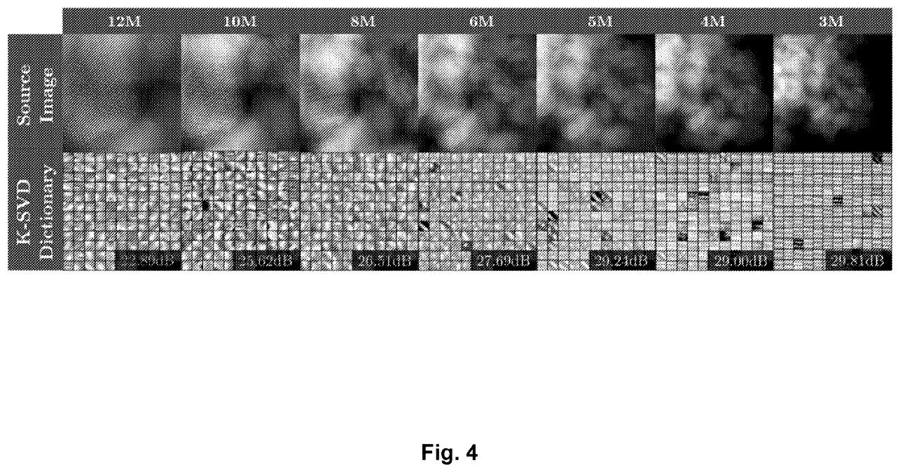

FIG. 4 shows the K-SVD generated dictionaries with elements of size [16×16] for each image of the sample at different magnifications, clearly showing the changes in learned features (and feature sizes) as the magnification is varied between 3M and 12M. For small changes in magnification, such as 12M to 10M or 3M to 4M, the set of features in the corresponding learned dictionaries appear very similar, but with a different ‘scaling’ or feature-size. For example, in the case of moving from 3M to 4M, both dictionaries contain mostly horizontally aligned stripes, yet the vertical scaling of the lines for the 4M dictionary is larger, with often only one dominant line (as compared with 2 for the 3M dictionary) appearing in each dictionary element. This is consistent with expectations, as (in reference to a [16×16] patch of the given image) the atomic planes appear larger (span more pixels) at a higher magnification.

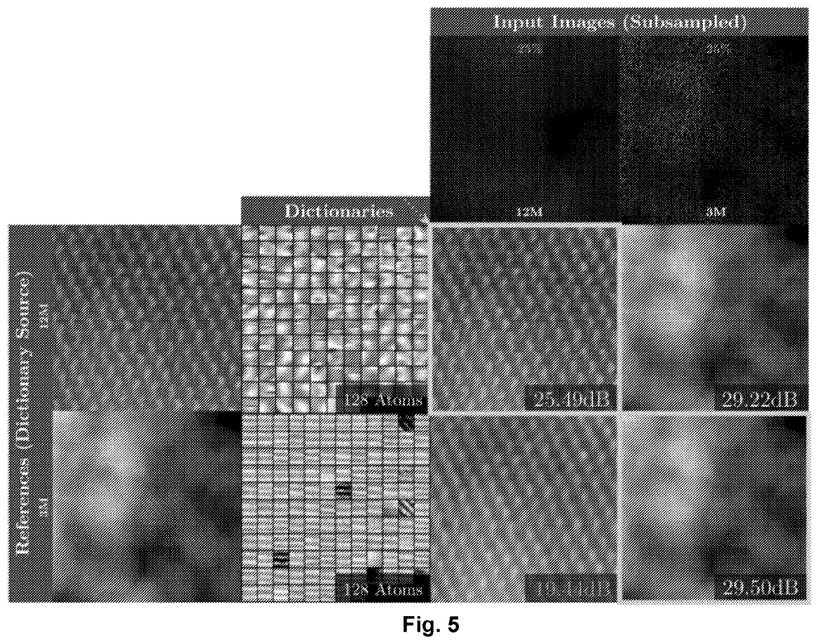

With a significant increase in magnification, previously unresolved atomic columns become visible, leading to many much finer and more unique features in the image. FIG. 5 shows reconstructions of a cropped region for both the 3M and 12M images, inpainted with their own dictionary and that at the opposing end of the magnification scale.

As shown in FIG. 5, in both ‘off-diagonal’ cases, while low-frequency information such as topology is recovered, most fine details are lost in reconstruction. For the 12M image, the atomic columns appear blurred, and for the 3M image, noise is again incurred, and the atomic planes are mostly absent. For the full results of this experiment, including images at all magnifications reconstructed with each dictionary along with the PSNR and SSIM quality metrics, see FIGS. 6 to 11 and the corresponding description.

### Discussion

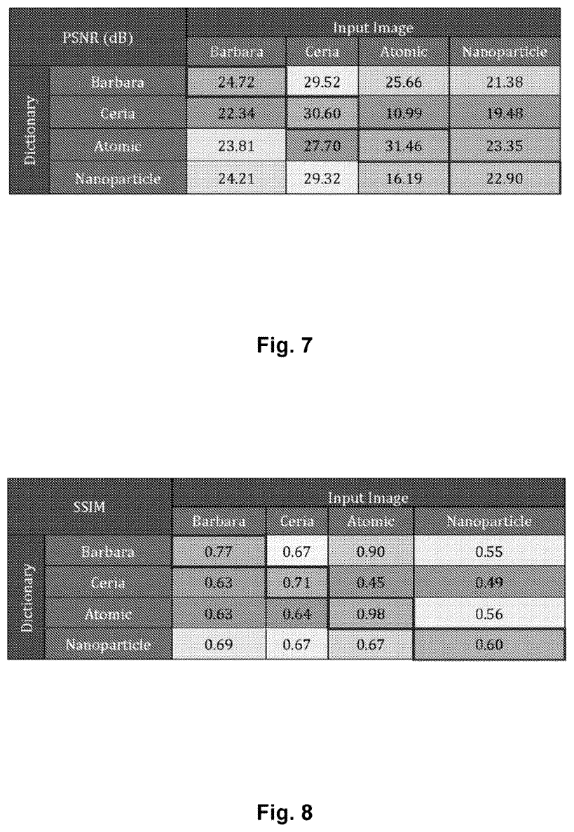

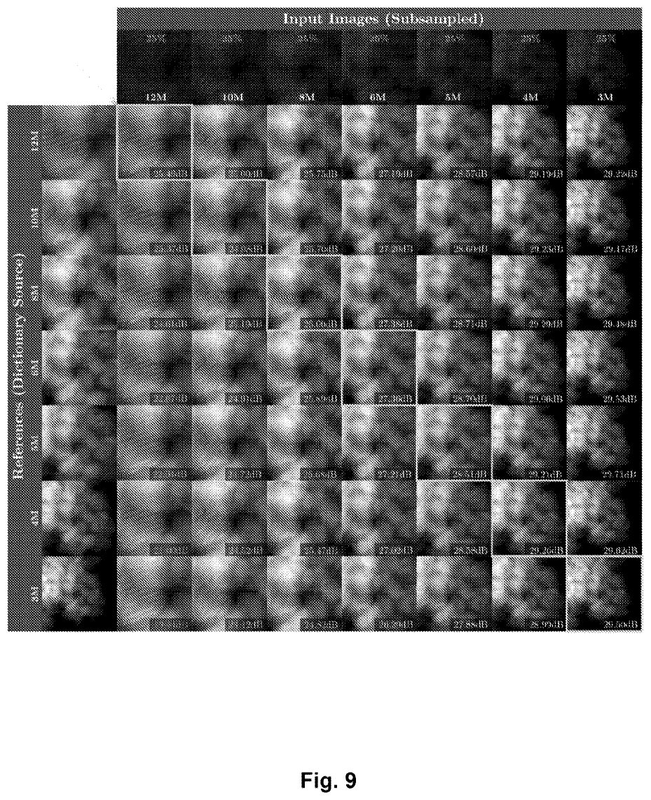

For each reconstruction performed in this paper, we have stated the PSNR (and, in FIGS. 6 to 11 and the corresponding description, the SSIM) quality metric as measured against the fully-sampled reference image used to generate the dictionary. In the first experiment (Dictionary Transfer), we investigated the performance of dictionary transfer across four different images, 3 of which were from an electron microscope. As shown in FIGS. 7 and 8, for both PSNR and SSIM, the highest quality reconstruction was achieved using the dictionary learned from the corresponding fully-sampled image (along the highlighted diagonal). In extreme cases, such as attempting to reconstruct the image ‘Atomic’ using the dictionary learned from the image ‘Ceria’, the very low metric value (such as 10.99 dB) is indicative of the poor reconstruction quality using the inappropriate dictionary elements. However, as shown in FIG. 2, in the case of reconstructing ‘Atomic’ with the elements learned from ‘Barbara’, while a very (visually) similar image is recovered, the PSNR value is much (˜6 dB) lower, suggesting a much worse reconstruction than is observed. While in this case, SSIM appeared to perform better as a predictor of reconstruction quality, it too was found to be limited as an overall metric for STEM image reconstruction analysis, especially for the results of the second experiment (Magnification/Feature Size) where (other than outliers) the difference in SSIM between the worst and the best reconstruction is often very marginal, despite the fact that in many cases, significant parts of the useful information (for STEM analysis) is completely lost. Additionally, these metrics are only able to be calculated as we have access to the fully-sampled reference images, something that is not possible in a true ‘real-time’ CS-STEM setup. For this reason, much of the discussion in this paper is qualitative (i.e. looking at the reconstructed images and determining how much critical information such as atomic plane spacing is retained) and not quantitative, suggesting that a novel quality metric (perhaps specific to STEM images) may be required in order to more accurately quantity these effects and/or enable reference-less calculation, though this is outside the scope of this paper.

The results of the first experiment (Dictionary Transfer) are very encouraging, appearing to suggest that if the training data (i.e. the patches of the reference image) is varied enough, such as in the case of the image ‘Barbara’, then (as illustrated in FIG. 3) the dictionary elements are able to combine to represent features which were completely absent from the source image (e.g. atomic circles). In fact, ‘Barbara’, which produced the most varied of dictionary elements (see FIG. 1) was able to reconstruct a reasonable image for all four test images (see FIG. 6) retaining much of the useful information in all cases. One observation from the results of experiment Dictionary Transfer is the importance of feature-size, and the complexity of the elements in the learned dictionary. For dictionaries with very specific elements, such as the dictionary (of only circular signals) learned from the ‘Atomic’ image, or dictionaries with many extremely similar elements such as the dictionary for the ‘Ceria’ image, the performance of the dictionary when transferred to another image is limited, these two dictionaries performed the worst (in general) for all images other than their corresponding reference. As shown in FIG. 2 and FIG. 6, the use of an inappropriate dictionary, especially with elements trained to represent feature-sizes smaller than are present in the (subsampled) input image often result in noisy reconstructions with artefacts of the limited ability of the dictionary elements to represent a given patch. This is most obvious in the reconstructions of ‘Barbara’ using the ‘Atomic’ dictionary, resulting in a very poor reconstruction (for all fine details) and a patchwork of ‘spots’ (dictionary artefacts) over the image, as well as the reconstruction of ‘Barbara’ with the ‘Ceria’ dictionary, which resulted in a very blurry image. However, this poor performance in dictionary transfer appears to be due to the limited range of dictionary elements required to reconstruct the types of signal patterns contained within the corresponding images; As previously discussed, this reduced complexity in reconstruction of STEM images compared with ‘natural’ images may be exploited as to produce a maximally representative (whilst still remining reasonably sized) dictionary able to reconstruct a wide range of images in STEM applications, further increasing the feasibility of building a ‘master’ dictionary for STEM research.

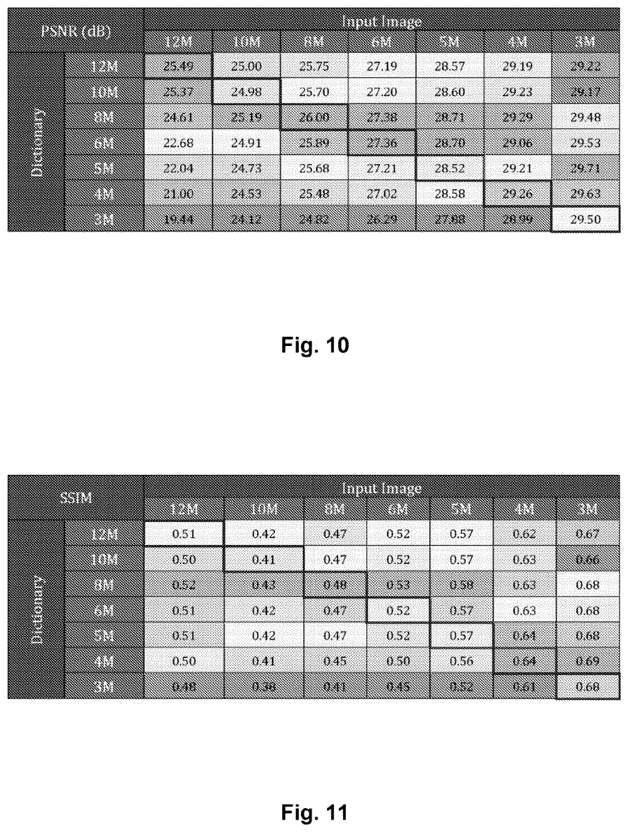

The second experiment (Magnification/Feature Size) investigated the cross-compatibility of STEM dictionaries of the same material at seven different magnifications, as an example of how ‘live’ microscope conditions affect reconstruction quality. As previously discussed, FIG. 4 shows how the feature-size (and content) of the learned dictionary elements changes as the magnification of the source image is varied. FIGS. 9 to 11 show the full results and quality metrics, once again aligning with expectations, showing that (in general), dictionaries learned at the appropriate magnification produce better reconstructions. It should be noted, however, that the ‘diagonal’ is much less pronounced in these results than for the first experiment, and the differences between the best and worst reconstructions is much smaller, suggesting these dictionaries are at least more cross-compatible than dictionaries from entirely different images. The results of the second experiment, while once again encouraging, suggest that any pre-learned (‘master’) dictionary trained for ‘real-time’ CS-STEM application must not only be able to represent a wide range of materials with vastly different features, but must also account for the different feature sizes required at different magnifications, even for the same material. As magnification is known at the point of acquisition, this could take the form of multiple, separate, pre-trained dictionaries for different feature sizes, instantly switched between according to the current magnification, or perhaps a method of adaptive dictionary element selection (pruning) and/or (re-)scaling in order to match the required feature size on-the-fly, potentially driven by a neural network.

The two experiments in this paper investigated the cross-compatibility of sparsifying dictionaries in general (Dictionary Transfer) and the effects of microscope magnification on the transferral of a dictionary between different images of the same sample (Magnification/Feature Size). In both cases, the results were encouraging, but highlighted aspects that would need to be considered for any true ‘real-time’ CS-STEM setup. Independent of the method chosen for learning a sparsifying basis and/or reconstructing the image (K-SVD, BPFA, neural networks etc.), our results suggest that the training data required for such a ‘master’ dictionary (or network) must be sufficiently extensive (resulting in a wide range of dictionary elements) in order to produce complex features, and must contain elements with the appropriate feature size, particularly in the case of STEM images which may be obtained at any magnification. However, in order to implement a ‘master’ dictionary in this way, there is a lot of work yet be done. Firstly, there are other microscope conditions mentioned, but not investigated here; such as the chosen detector (ABF/HAADF) and focus condition, which also dramatically alter the appearance of the acquired image, and thus must be accounted for (i.e. representable) by the elements of the (or an alternate) ‘master’ dictionary. Once each of these effects has been determined, and a strategy devised to account for each, the next step will be the formation/training of the ‘master’ dictionary. At this point, a method must be determined for producing a dictionary which is representative of the widest range of STEM images whilst remaining as small (number of elements) as possible as time-to-solution often scales linearly with dictionary size. For this, we envision an extension of current dictionary learning methods, operating on a large dataset of STEM images, iteratively converging on elements which are maximally representative of image patches across the entire dataset; this algorithm would likely require a constraint to limit the visual similarity of any two elements within the dictionary, perhaps calculated via their mutual coherence, or perhaps SSIM. Further to this, our results suggest that current image quality metrics (PSNR and SSIM), are inadequate as a predictor of image quality for STEM reconstructions, often giving high values for (objectively) poor reconstructions and vice-versa. Even without these limitations, these metrics are only possible when one has access to a fully-sampled reference image, something which is not possible when performing CS-STEM on beam-sensitive materials using only subsampled acquisition. Therefore, future work on CS-STEM may require the development of an alternate reconstruction quality metric, placing more weight the preservation of fine details (such as atomic planes) rather than the low-frequency topographical features such general contrast.

When developing a ‘master’ dictionary, one may also want a metric to quantify the ability of a given dictionary to represent a wide range of STEM images, likely taking into account the variety and orthogonality of the dictionary elements present, but also may benefit from an extension of the previously proposed reconstruction metric across the dataset. In order to keep the time-to-solution for ‘live’ sparse-pursuit based reconstructions as small as possible, one may wish to implement an efficient dictionary ‘pruning’ strategy on a per-patch basis, providing each sparse-coding step with a reduced set of dictionary elements most appropriate to the (subsampled) input patch. Previous work has already demonstrated the ability of dictionary learning methods to separate different feature-types into multiple dictionaries, referred in the literature as ‘Cartoon’ and ‘Texture’ features (representing the low-frequency signals and high-frequency fine details of an image respectively). This method may be leveraged to provide a single ‘Cartoon’ dictionary for all images, whilst swapping between the most appropriate ‘Texture’ dictionary to represent fine details for a given material, magnification or focus condition, all whilst further reducing the overall time-to-solution.

Any process of generating a ‘master’ dictionary which is maximally representative of a wide range of STEM images will require the gathering of a large dataset of training data. For currently imageable materials (in STEM), this will likely be in the form of fully-sampled data, and thus, the dictionary learning algorithm may take many forms. If this process were to be successful, it appears likely from our results that this pre-trained dictionary alone may be appropriate enough to enable ‘real-time’ reconstructions of these (known to be well represented) materials without the need for any further training, skipping the dictionary learning step entirely, and thus significantly reducing time-to-solution. For other materials, it may also be the case that the pre-trained dictionary (especially via the combination of many different elements, as illustrated in FIG. 3) is sufficient for the inpainting of previously unseen signals in images of beam-sensitive materials; however it is likely that in this case, some further training of the dictionary will be required in order to account for any completely novel features contained within images outside of the available training data. Even in this case however, the existence of a ‘master’ dictionary will be able to reduce the time-to-solution for such reconstructions, as it may be used as the initialiser for a shortened dictionary learning process, effectively providing a “hot start” for the algorithm, resulting in faster reconstructions even for blind inpainting methods. Furthermore, when training such a dictionary, the specific use-case may be leveraged to produce even more efficient dictionaries for a given application. As discussed previously, in addition to the material/image(s) used in training, different microscope conditions (such as magnification) also impact the cross-compatibility of a given dictionary; this suggests that better quality reconstructions may be obtained by training dictionaries more specifically for the use-case, such as a dictionary trained to accurately reconstruct images of a silicon microprocessor at a specific magnification. In this case, after each final acquisition is taken, and subsequently reconstructed, a short dictionary learning step may be performed to further improve the given dictionary, resulting in a continuously improving ‘master’ dictionary for specific applications.

Finally, as is the case for many fields involving image processing, as the speed and accuracy of neural networks continues to improve, and consumer hardware becomes more and more efficient at machine learning, we must consider the application of a neural network in place of traditional compressive sensing methods. Neural networks have already successfully been applied to image inpainting tasks, such as image denoising auto-encoders, the removal of text from an image and the use of generative adversarial networks (GANs) to inpaint large regions of an image. Similar to the concept of a ‘master’ dictionary, a neural network trained on a sufficiently large dataset, able to inpaint an image (or patch) with an arbitrary mask may produce similar, if not superior results in a shorter amount of time when compared to traditional sparse-coding methods.

### CONCLUSION

The aim of this paper was to perform an initial investigation into the feasibility of dictionary transfer in general and a pre-trained ‘master’ dictionary for ‘live’ CS-STEM. We performed two experiments to investigate how well a dictionary learned from one image is able to reconstruct another, completely different signal and the effects of varying magnification for reconstructing images of the same sample with dictionaries learned at different magnifications. Our results show the (at times unintuitive) ability of a sufficiently complex dictionary to represent completely novel features (i.e. features that were not present in the image used in training). This suggests that if an appropriately generic and representative ‘master’ dictionary was formed, dictionary transfer provides a mechanism to significantly reduce the computation required to fit a dictionary, or in some cases to skip the learning stage altogether when reconstructing images of different samples, or different frames of the same sample at different microscope conditions. While much work is yet to be done, these results show that significantly reducing the time-to-solution for reconstructing subsampled STEM images via the formation of a maximally representative dictionary is possible, bringing us a step closer to a true application of ‘real-time’ CS-STEM.

### Real-Time Dictionary Transfer

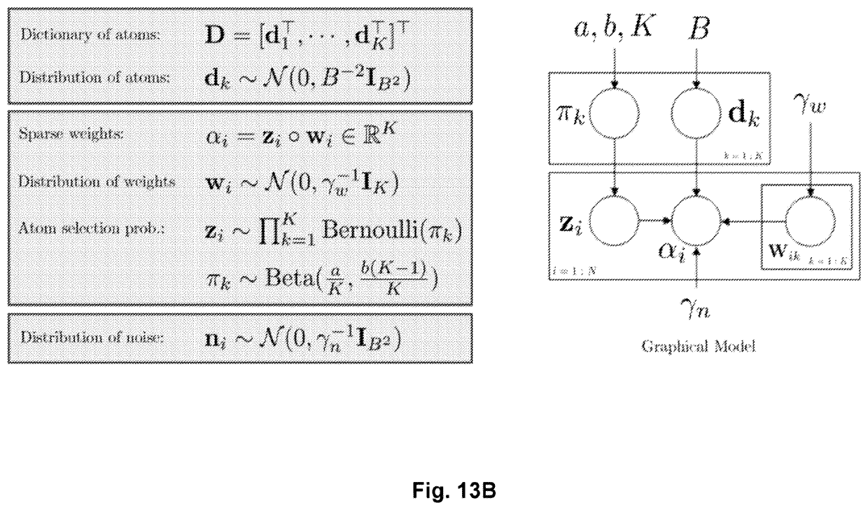

FIG. 13A schematically depicts a new method for real-time dictionary transfer according to an exemplary embodiment, using separate training and reconstruction instances of BPFA (each with their own set of parameters and coefficients) operating on the same transient dictionary Dₜ; and FIG. 13B shows definitions of parameters for the method of FIG. 13A.

Extending the concepts described above, a new method of achieving (now real-time) dictionary transfer is briefly as follows:
An initial dictionary D₀ is initialised (e.g. generated randomly or imported from a previous result) with parameters governing the dimensionality of the dictionary, and Bayesian priors denoting the probability of element selection, noise variance e.t.c.
Two instances of BPFA are initialised, each with a different input source. The training instance Io takes the image we wish to transfer from as its input, while the reconstruction instance I₁ takes the image we wish to transfer to as its input. Both share a connection to the same transient dictionary Dₜ.
The training and reconstruction iterations are performed sequentially/in parallel (in any order). In each iteration, the transient dictionary pixels (and parameters) are updated by the training loop, resulting in the dictionary learning the features of the transfer source Y₀. Simultaneously, the statistical parameters (e.g. π) of the dictionary are updated by the reconstruction loop, allowing the dictionary to converge to a solution containing the features of Y₀, and the selection probability (i.e. BPFA priors/parameters) governed by the target Y₁.
At any given step, a visualisation [symbol] may be produced, representing the projection/reconstruction of the subsampled target as a product of the dictionary learned from the transfer source, and the appropriate coefficients determined by the reconstruction instance, thereby allowing for real-time dictionary transfer.

In more detail, the sixth aspect provides a method of real-time dictionary transfer, the method implemented by a computer comprising a processor and a memory, the method comprising: initialising an initial dictionary Do, for example wherein the initial dictionary is generated randomly or imported such as from a previous result, with parameters governing dimensionality and/or sparsity of the dictionary and/or Bayesian priors, for example denoting respective probabilities of element selection, noise variance, etc.;
initialising a first instance of BPFA with a transfer source Y₀ (i.e. a first input source such as a training image), wherein the first instance of BPFA comprises and/or is a training instance I₀ of BPFA, for example wherein the training instance/, of BPFA takes the transfer source Y₀ to be transferred from as an input thereof, having a first connection, for example a shared connection, to a transient dictionary Dₜ derived from the initial dictionary D₀;
initialising a second instance of BPFA with a target source Y₁ (i.e. a second input source such as a subsampled image to be inpainted), wherein the transfer source Y₀ and the target source Y₁ are mutually different, wherein the second instance of BPFA comprises and/or is a reconstruction instance I₁ of BPFA, for example wherein the reconstruction instance I₁ of BPFA takes an image to be transferred to as an input thereof, having a second connection, for example a shared connection, to the transient dictionary Dₜ (i.e. the same transient dictionary Dₜ);
performing one or more training iterations and reconstruction iterations (also known as loops), for example serially (i.e. sequentially, consecutively, alternately) and/or in parallel (i.e. simultaneously, concurrently), using the first instance of BPFA and the second instance of BPFA, respectively, comprising, for each respective training iteration and reconstruction iteration:
   updating, by the first instance of BPFA (i.e. the training instance I₀ of BPFA) during the training iteration (for example, during each training iteration), pixels of the transient dictionary Dₜ (and optionally, statistical parameters thereof, for example π, γ_{ϵ}, γ_{d}, γ_{ω}), whereby the transient dictionary Dₜ learns the features of the transfer source Y₀; and updating, by the second instance of BPFA (i.e. the reconstruction instance I₁ of BPFA) during the reconstruction iteration (for example, during each reconstruction iteration), statistical parameters, for example π, γ_{ϵ}, γ_{d}, γ_{ω}) of the transient dictionary Dt, whereby the transient dictionary Dₜ converges, for example after a plurality of iterations, thereby containing features of the transfer source Y₀ and/or selection probabilities (such as BPFA priors/parameters) governed by the target source Y₁; and
producing, using the transient dictionary Dₜ, a visualisation [symbol] , representing a reconstruction of the target source Y₁ (i.e. reconstructing a visualisation [symbol] of the target source Y₁ using the transient dictionary Dₜ).

In this way, the method provides real-time dictionary transfer, for example for real-time CS-STEM as described herein. The visualisation [symbol] , representing the reconstruction of the target source Y₁, is a product of the transient dictionary Dₜ, learned from the transfer source Y₀, and the appropriate coefficients determined by the reconstruction instance I₁ of BPFA, thereby providing real-time dictionary transfer.

The method according to the sixth aspect may include any step and/or feature as described with respect to the first aspect and/or the second aspect.

During initialization, the following parameters are set and are not altered by either instance of BPFA:
K: Size of the dictionary/No. of elements [governs dimensionality]
B: Shape of the dictionary elements/patches [governs dimensionality]
πₐ, π_{b}: (shown as a, b in FIG. 13B): Hyper-parameters [governs element sparsity]

The following parameters are related to the statistical properties of the BPFA algorithm and are updated by BOTH instances (i.e. the reconstruction instance continues to fit the statistical parameters to the subsampled input, despite not affecting the dictionary elements themselves):
π also shown as πₖ: Bayesian prior, essentially a measure of the global probability of selection for a given dictionary element.
γ_{ω}: Precision of the weights/coefficients [shown in in FIG. 13B]
γ_{ϵ}: Precision of the noise [shown as γₙ in FIG. 13B]
γ_{d}: Precision of the dictionary elements [not shown in in FIG. 13B]

The initial dictionary is just used to initialise a transient dictionary Dₜ, it could be totally randomly generated, be some form of transform dictionary e.g. DCT, in both cases, parameters are initialised to default values. Additionally, it could be loaded back in from previous experiments (along with its parameters).

In the case of reconstructing a single image (where the pixel values of the image are constant), then a dictionary will converge to a final solution and the changes to the dictionary upon each update will tend to zero, at this point we may stop training and consider it a final dictionary. However. this form of using a transient dictionary, as showed in the flow chart if FIG. 13A, is really designed for a time-variable input feed, i.e. a subsampled target such as the target source Y₁, which is constantly changing, such as the output feed of an electron microscope, or a webcam. In this case, as the features of the image are continuously changing, the dictionary will continue to learn features and evolve to account for new information indefinitely, until we stop the process of viewing the reconstruction in real-time.

### GLOSSARY OF TERMS

ABF: Annular Bright-Field. A method of imaging samples in STEM using bright-field detectors in which an image formed using a ring-shaped detector by low-angled forward scattered electrons, not including the most central part of the transmitted beam.
CS-STEM: Compressive-Sensing (driven) Scanning Transmission Electron Microscopy. The acquisition and subsequent reconstruction of a full image of a given sample using only subsampled measurements.
DCT: Discrete Cosine Transform. A transform of a signal or image from the spatial domain to the frequency domain using sinusoidal functions (in this context, discretised into a set of dictionary elements)
HAADF: High-Angle Annular Dark-Field. A method of imaging samples in STEM by collecting scattered electrons with an annular dark-field detector lying outside of the path of the transmitted electron beam.
K-SVD: Dictionary Learning algorithm performing generalised K-Means clustering via Singular Value Decomposition (alternating between a sparse coding step and updating individual dictionary atoms to better fit the data).
I₀ Norm: The count of the total number of non-zero elements of a given vector.

$${‖ e ‖}_{0} = {\sum }_{i} ( {\vert {e}_{i} \vert}^{0} )$$

I₁ Norm: The sum of the magnitudes of all elements in a given vector.

$${‖ e ‖}_{1} = {\sum }_{i} ( {\vert {e}_{i} \vert}^{1} )$$

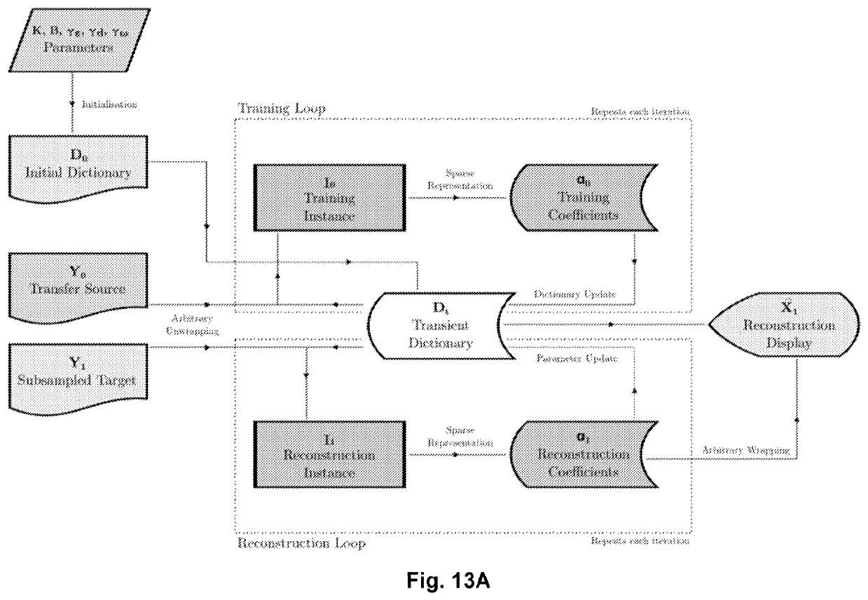

MOD: Method of Optimal Directions. One of the first sparse dictionary learning algorithms developed in, alternating between a sparse coding step and updating the dictionary via matrix pseudo-inverse calculations
OMP: Orthogonal Matching Pursuit.
PSNR: Peak-Signal-to-Noise-Ratio. An image quality metric measuring the ratio between the maximal power of a signal and the power of corrupting noise, as measured against a reference image.
SSIM: Structural Similarity Index. An image quality metric measuring the visible structural similarity (between two images).
BPFA instance (I_{X}): An independent instance of the BPFA algorithm, parameters, data storage, and solution (coefficients). Each instance operates on a single input signal (Y) and dictionary (D) and attempts to find a sparse representation and/or learn an appropriate dictionary from the given input signal. Multiple instances may share the same input and/or dictionary.
Arbitrary Unwrapping: Efficient generation/extraction of an arbitrary (e.g. programmatically indexed) batch of the input signal y from the full input Y.
Arbitrary Wrapping: Efficient recombination of the full \hat{X} from an arbitrary set of coefficients (α) and the corresponding dictionary (D) [potentially forming an incomplete image, [symbol] ]
Traditional (BPFA) Reconstruction: Almost all previous implantations of BPFA dictionary learning and image reconstruction are designed in the following way: one (i.e. a single) instance of the BPFA algorithm is initialised, a series of dictionary learning steps/batches are performed (See FIGS. 12A and 12B).
Frame Reconstruction (\hat{X}): The complete reconstruction of a given frame using a static/unchanging dictionary. (i.e. a projection of \hat{X}=Dα after a complete epoch of sparse-coding since the frame was received) (See FIG. 12C). (x):
   n.b. As the dictionary is unchanged throughout the epoch of sparse coding, all of the sparse representations of patches (coefficients of α) rely on the same dictionary (D), thus more accurately representing the target frame.
Transient Dictionary (Dₜ): A dictionary of elements which is subject to constant change of both the pixel values and parameters between iterations of the BPFA algorithm i.e. the specific dictionary ‘seen’ by each batch/iteration for a given BPFA instance exists only during that batch/iteration, as the dictionary elements may/will be updated by a separate instance at regular intervals throughout each epoch of sparse coding.
Visualization ( [symbol] ): Any projection of [symbol] =Dₜα, where Dₜ is a transient dictionary, or an inter-epoch projection of \hat{X}=Dα (for any dictionary), forming an incomplete reconstruction (See FIG. 12D).
   n.b. This means that during the course of an epoch reconstructing/visualising with a transient dictionary, rows of a calculated in previous batches may have been determined using a dictionary with different pixel values in the chosen dictionary elements. This results in a slight divergence from the original solution for each previously encoded overlapping patch—this could be a positive or negative change with respect to the overall reconstruction quality.

Although a preferred embodiment has been shown and described, it will be appreciated by those skilled in the art that various changes and modifications might be made without departing from the scope of the invention, as defined in the appended claims and as described above.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of reconstructing an electron microscopy image of size [M×N] pixels of a first sample, the method implemented by a computer comprising a processor and a memory, the method comprising:
providing a set of pre-learned dictionaries, including a first pre-learned dictionary including a set of p₁ atoms;
acquiring a sparse set of S acquired sub-images, including a first sub-image of size [a×b] pixels wherein a, b∈[2, min{M, N}], of the first sample; and
reconstructing the electron microscopy image of the first sample using the sparse set of S sub-images of the first sample and the set of pre-learned dictionaries.

2. The method according to claim 1, wherein the set of pre-learned dictionaries includes a second pre-learned dictionary comprising a set of p₂ atoms; and
wherein reconstructing the electron microscopy image of the first sample using the sparse set of S sub-images of the first sample and the set of pre-learned dictionaries comprises reconstructing the electron microscopy image of the first sample using the sparse set of S sub-images of the first sample and a combination of the first pre-learned dictionary and the second pre-learned dictionary.

3. The method according to claim 2, wherein the combination of the first pre-learned dictionary and the second pre-learned dictionary comprises and/or is a pair-wise combination of the first pre-learned dictionary and the second pre-learned dictionary.

4. The method according to claim 1, comprising training the first pre-learned dictionary using the using the sparse set of S sub-images of the first sample.

5. The method according to claim 4, wherein reconstructing the electron microscopy image of the first sample using the sparse set of S sub-images of the first sample and the set of pre-learned dictionaries comprises reconstructing the electron microscopy image of the first sample using the sparse set of S sub-images of the first sample and the first pre-learned dictionary trained using the using the sparse set of S sub-images of the first sample.

6. The method according to claim 1, comprising selecting a subset of
$${p}_{1}^{′}$$
atoms from the set of p₁ atoms included in the first pre-learned dictionary; and
wherein reconstructing the electron microscopy image of the first sample using the sparse set of S sub-images of the first sample and the set of pre-learned dictionaries comprises reconstructing the electron microscopy image of the first sample using the sparse set of S sub-images of the first sample and the selected subset of
$${p}_{1}^{′}$$
atoms included in the first pre-learned dictionary.

7. The method according to claim 6, wherein selecting the subset of
$${p}_{1}^{′}$$
atoms from the set of p₁ atoms included in the first pre-learned dictionary comprises selecting the subset of
$${p}_{1}^{′}$$
atoms from the set of p₁ atoms included in the first pre-learned dictionary based on residual energies of the respective atoms of the set of p₁ atoms.

8. The method according to claim 1, wherein providing the first pre-learned dictionary including the set of p₁ atoms comprises training a dictionary using a fully sampled acquired electron microscopy image of a second sample and/or a fully sampled simulated electron microscopy image of the second sample.

9. The method according to claim 8, wherein the first sample and the second sample are mutually different.

10. The method according to claim 1, comprising transforming one or more atoms of the set of p₁ atoms included in the first pre-learned dictionary.

11. A method of controlling an electron microscope, the method implemented, at least in part, by a computer comprising a processor and a memory, the method comprising:
obtaining parameters of the electron microscopy;
acquiring a first sparse set of S acquired sub-images of a first sample comprising controlling the electron microscope using the obtained parameters of the electron microscopy;
reconstructing a first electron microscopy image of size [M×N] pixels of the first sample according to claim 1 using the first sparse set of S sub-images of the first sample;
comparing the first electron microscopy image against thresholds of one or more target properties of the first electron microscopy image;
adapting the parameters of the electron microscopy based on a result of the comparing; and
acquiring a second sparse set of S acquired sub-images of the first sample comprising controlling the electron microscope using the adapted parameters of the electron microscopy.

12. The method according to claim 11, comprising:
reconstructing a second electron microscopy image of size [M×N] pixels of the first sample using the second sparse set of S sub-images of the first sample.

13. (canceled)

14. An electron microscope including a computer comprising a processor and a memory configured to implement a method according to claim 1.

15. (canceled)
